(19) United States
(12) Patent Application Publication
(10) Pub. No.: US 2024/0396589 A1
(43) Pub. Date: Nov. 28, 2024

(54) TECHNIQUES FOR CONFIGURING COMMUNICATIONS ASSOCIATED WITH RECONFIGURABLE INTELLIGENT SURFACES

(71) Applicant: QUALCOMM Incorporated, San Diego, CA (US)

(72) Inventors: Saeid SAHRAEI, San Diego, CA (US); Yu ZHANG, San Diego, CA (US); Hung Dinh LY, San Diego, CA (US); Krishna Kiran MUKKAVILLI, San Diego, CA (US)

(21) Appl. No.: 18/686,333

(22) PCT Filed: Oct. 25, 2021
(86) PCT No.: PCT/CN2021/125985

§ 371 Date: Feb. 23, 2024

(51) Int. Cl. H04B 7/04; H04B 7/06; H04L 5/00

(52) U.S. Cl. CPC H04B 7/04013; H04B 7/0696; H04L 5/0042; H04L 5/006

(57) ABSTRACT

Methods, systems, and devices for wireless communications are described. A user equipment (UE) may transmit an indication of a plurality of beams received by the UE. The UE may receive a message indicating at least a first resource set associated with one or more first beams from the plurality of beams and a second resource set associated with one or more second beams from the plurality of beams. The UE may transmit a report indicative of a level of correlation between pairs of individual beams, each pair including a first individual beam of the one or more first beams and a second individual beam of the one or more second beams, and the UE may communicate with the base station via a selected beam of the one or more first beams or the one or more second beams.

### CROSS REFERENCE

The present application is a 371 national stage filing of International PCT Application No. PCT/CN2021/125985 by SAHRAEI et al. entitled “TECHNIQUES FOR CONFIGURING COMMUNICATIONS ASSOCIATED WITH RECONFIGURABLE INTELLIGENT SURFACES,” filed Oct. 25, 2021, which is assigned to the assignee hereof, and which is expressly incorporated by reference in its entirety herein.

### FIELD OF TECHNOLOGY

The following relates to wireless communications, including techniques for configuring communications associated with reconfigurable intelligent surfaces (RISs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless communications systems may support beamforming techniques for communications between wireless devices. In some examples, wireless communications systems may include reconfigurable intelligent surfaces (RISs) to facilitate transmissions between wireless devices. A RIS may include a quantity of reflective, electrically-controllable elements. The RIS may reflect transmissions in a specific direction based on a current configuration of the RIS elements. For example, a RIS may receive a beamformed communication at an angle of incidence and may reflect the beamformed communication at an angle different from the angle of incidence. In some cases, beamformed communications reflected by a RIS may be referred to as RIS-aided communications or RIS-aided transmissions. In some cases, methods for using such RISs to support communications between a UE and a base station may be improved.

### SUMMARY

The described techniques relate to improved methods, systems, devices, and apparatuses that support techniques for configuring communications associated with reconfigurable intelligent surfaces (RISs). Generally, the described techniques provide for improved methods for configuring communications across multiple RISs so as to reduce interference at one or more user equipment's (UEs). The methods may include a UE indicating to a base station a level of correlation between one or more downlink beams, such as downlink beams from one or more RISs. The base station may utilize the level of correlation information to configure communications across RISs so as to refrain from using correlated beams at the same time. For example, a UE may receive one or more signals (e.g., reference signals) from a base station via one or more RISs and the UE may transmit, to the base station, an indication of a plurality of beams on which the UE receives the signals from the base station. The base station may identify that the UE indicated at least one beam that is associated with a first RIS and at least one beam that is associated with a second RIS.

Accordingly, the base station may transmit, based on receiving the indication, a message indicating at least a first resource set associated with one or more first beams from the plurality of beams and a second resource set associated with one or more second beams from the plurality of beams. Such a message may prompt the UE to monitor for signals via the first resource set and the second resource set. Based on the monitoring, the UE may perform channel estimation for each beam of the one or more first beams and the one or more second beams. The UE may then determine a level of correlation (e.g., association, incompatibility) between beam pairs based on the channel estimation for each beam. The UE may transmit a report indicative of a level of correlation between pairs of individual beams, where each pair may include a first individual beam of the one or more first beams and a second individual beam of the one or more second beams. The base station may configure RISs to use beams that do not interfere with beams from one or more other RISs based on the report. The UE may communicate with the base station via a selected beam of the one or more first beams or the one or more second beams based on transmitting the report.

A method for wireless communications at a user equipment (UE) is described. The method may include transmitting, to a base station, an indication of a set of multiple beams received by the UE, receiving, based on transmitting the indication, a message indicating at least a first resource set associated with one or more first beams from the set of multiple beams and a second resource set associated with one or more second beams from the set of multiple beams, transmitting a report indicative of a level of correlation between pairs of individual beams, each pair including a first individual beam of the one or more first beams and a second individual beam of the one or more second beams, and communicating with the base station via a selected beam of the one or more first beams or the one or more second beams.

An apparatus for wireless communications at a UE is described. The apparatus may include a processor, memory coupled with the processor, and instructions stored in the memory. The instructions may be executable by the processor to cause the apparatus to transmit, to a base station, an indication of a set of multiple beams received by the UE, receive, based on transmitting the indication, a message indicating at least a first resource set associated with one or more first beams from the set of multiple beams and a second resource set associated with one or more second beams from the set of multiple beams, transmit a report indicative of a level of correlation between pairs of individual beams, each pair including a first individual beam of the one or more first beams and a second individual beam of the one or more second beams, and communicate with the base station via a selected beam of the one or more first beams or the one or more second beams.

Another apparatus for wireless communications at a UE is described. The apparatus may include means for transmitting, to a base station, an indication of a set of multiple beams received by the UE, means for receiving, based on transmitting the indication, a message indicating at least a first resource set associated with one or more first beams from the set of multiple beams and a second resource set associated with one or more second beams from the set of multiple beams, means for transmitting a report indicative of a level of correlation between pairs of individual beams, each pair including a first individual beam of the one or more first beams and a second individual beam of the one or more second beams, and means for communicating with the base station via a selected beam of the one or more first beams or the one or more second beams.

A non-transitory computer-readable medium storing code for wireless communications at a UE is described. The code may include instructions executable by a processor to transmit, to a base station, an indication of a set of multiple beams received by the UE, receive, based on transmitting the indication, a message indicating at least a first resource set associated with one or more first beams from the set of multiple beams and a second resource set associated with one or more second beams from the set of multiple beams, transmit a report indicative of a level of correlation between pairs of individual beams, each pair including a first individual beam of the one or more first beams and a second individual beam of the one or more second beams, and communicate with the base station via a selected beam of the one or more first beams or the one or more second beams.

Some examples of the method, apparatuses, and non-transitory computer-readable medium described herein may further include operations, features, means, or instructions for receiving a second signal via each of the one or more first beams and the one or more second beams in accordance with the first resource set and the second resource set and performing channel estimation for each of the one or more first beams and the one or more second beams based on the received second signals.

Some examples of the method, apparatuses, and non-transitory computer-readable medium described herein may further include operations, features, means, or instructions for determining the level of correlation between the individual beams in each pair based on the channel estimation of the one or more first beams and the one or more second beams.

In some examples of the method, apparatuses, and non-transitory computer-readable medium described herein, transmitting the report may include operations, features, means, or instructions for transmitting the report including an indication of the level of correlation for a top number of beam pairs associated with a highest level of correlation.

In some examples of the method, apparatuses, and non-transitory computer-readable medium described herein, the level of correlation includes a pair of resource indices for each of the top number of beam pairs, a first resource index associated with the first resource set and a second resource index associated with the second resource set.

Some examples of the method, apparatuses, and non-transitory computer-readable medium described herein may further include operations, features, means, or instructions for ranking levels of correlations for each pair from the highest level of correlation to a lowest level of correlation, where the indication includes the ranked list.

In some examples of the method, apparatuses, and non-transitory computer-readable medium described herein, the report includes a measured level of correlation between the individual beams in each pair.

In some examples of the method, apparatuses, and non-transitory computer-readable medium described herein, transmitting the indication of the set of multiple beams may include operations, features, means, or instructions for measuring a set of multiple signals received by the UE, each signal of the set of multiple signals received over a different beam of the set of multiple beams, where the indication of the set of multiple beams may be based on the measuring and includes a number of strongest measured signals.

In some examples of the method, apparatuses, and non-transitory computer-readable medium described herein, transmitting the indication of the set of multiple beams may include operations, features, means, or instructions for transmitting a measurement associated with each of the set of multiple beams.

Some examples of the method, apparatuses, and non-transitory computer-readable medium described herein may further include operations, features, means, or instructions for transmitting the indication of the set of multiple beams may be based on the set of multiple beams being associated with a measured signal greater than a threshold.

In some examples of the method, apparatuses, and non-transitory computer-readable medium described herein, the first resource set may be associated with a first reconfigurable intelligent surface and the second resource set may be associated with a second reconfigurable intelligent surface.

In some examples of the method, apparatuses, and non-transitory computer-readable medium described herein, a size of the first resource set may be based on the set of multiple beams received by the UE via the first reconfigurable intelligent surface and a size of the second resource set may be based on the set of multiple beams received by the UE via the second reconfigurable intelligent surface.

In some examples of the method, apparatuses, and non-transitory computer-readable medium described herein, communicating with the base station via the selected beam may include operations, features, means, or instructions for communicating with the base station via the selected beam and the first reconfigurable intelligent surface or the second reconfigurable intelligent surface.

A method for wireless communications at a base station is described. The method may include receiving, from a UE, an indication of a set of multiple beams received by the UE, transmitting, based on receiving the indication, a message indicating at least a first resource set associated with one or more first beams from the set of multiple beams and a second resource set associated with one or more second beams from the set of multiple beams, receiving a report indicative of a level of correlation between pairs of individual beams, each pair including a first individual beam of the one or more first beams and a second individual beam of the one or more second beams, and communicating with the UE via a selected beam of the one or more first beams or the one or more second beams.

An apparatus for wireless communications at a base station is described. The apparatus may include a processor, memory coupled with the processor, and instructions stored in the memory. The instructions may be executable by the processor to cause the apparatus to receive, from a UE, an indication of a set of multiple beams received by the UE, transmit, based on receiving the indication, a message indicating at least a first resource set associated with one or more first beams from the set of multiple beams and a second resource set associated with one or more second beams from the set of multiple beams, receive a report indicative of a level of correlation between pairs of individual beams, each pair including a first individual beam of the one or more first beams and a second individual beam of the one or more second beams, and communicate with the UE via a selected beam of the one or more first beams or the one or more second beams.

Another apparatus for wireless communications at a base station is described. The apparatus may include means for receiving, from a UE, an indication of a set of multiple beams received by the UE, means for transmitting, based on receiving the indication, a message indicating at least a first resource set associated with one or more first beams from the set of multiple beams and a second resource set associated with one or more second beams from the set of multiple beams, means for receiving a report indicative of a level of correlation between pairs of individual beams, each pair including a first individual beam of the one or more first beams and a second individual beam of the one or more second beams, and means for communicating with the UE via a selected beam of the one or more first beams or the one or more second beams.

A non-transitory computer-readable medium storing code for wireless communications at a base station is described. The code may include instructions executable by a processor to receive, from a UE, an indication of a set of multiple beams received by the UE, transmit, based on receiving the indication, a message indicating at least a first resource set associated with one or more first beams from the set of multiple beams and a second resource set associated with one or more second beams from the set of multiple beams, receive a report indicative of a level of correlation between pairs of individual beams, each pair including a first individual beam of the one or more first beams and a second individual beam of the one or more second beams, and communicate with the UE via a selected beam of the one or more first beams or the one or more second beams.

Some examples of the method, apparatuses, and non-transitory computer-readable medium described herein may further include operations, features, means, or instructions for transmitting the signal to the UE via at least a first reconfigurable intelligent surface and a second reconfigurable intelligent surface.

Some examples of the method, apparatuses, and non-transitory computer-readable medium described herein may further include operations, features, means, or instructions for determining that the indication of the set of multiple beams includes the one or more first beams associated with the first a reconfigurable intelligent surface and includes the one or more second beams associated with the second reconfigurable intelligent surface and determining the first resource set and the second resource set based on the indication of the set of multiple beams including beams associated with different reconfigurable intelligent surfaces.

In some examples of the method, apparatuses, and non-transitory computer-readable medium described herein, determining the first resource set and the second resource set may include operations, features, means, or instructions for determining a size of the first resource set based on a number of beams included in the one or more first beams and a size of the second resource set based on a number of beams included in the one or more second beams.

In some examples of the method, apparatuses, and non-transitory computer-readable medium described herein, communicating with the UE via the selected beam may include operations, features, means, or instructions for selecting a beam to communicate with the UE based on the report, where the selected beam may be based on the selecting and communicating with the UE via the selected beam, where the selected beam may be associated with the first reconfigurable intelligent surface or the second reconfigurable intelligent surface.

Some examples of the method, apparatuses, and non-transitory computer-readable medium described herein may further include operations, features, means, or instructions for determining a second beam to communicate with a second UE based on the report and the selected beam.

Some examples of the method, apparatuses, and non-transitory computer-readable medium described herein may further include operations, features, means, or instructions for transmitting a second signal to the UE via the one or more first beams of the first reconfigurable intelligent surface and the one or more second beams of the second reconfigurable intelligent surface based on transmitting the message indicating the first resource set and the second resource set.

Some examples of the method, apparatuses, and non-transitory computer-readable medium described herein may further include operations, features, means, or instructions for receiving a set of multiple reports indicative of the level of correlation between pairs of individual beams, identifying one or more individual beams indicated in more than one of the set of multiple reports, and determining to prohibit communications via the one or more individual beams based on the one or more individual beams being indicated in the more than one of the set of multiple reports.

Some examples of the method, apparatuses, and non-transitory computer-readable medium described herein may further include operations, features, means, or instructions for determining a reconfigurable intelligent surface associated with the one or more individual beams and transmitting a message to the reconfigurable intelligent surface prohibiting use of the one or more individual beams by the reconfigurable intelligent surface.

In some examples of the method, apparatuses, and non-transitory computer-readable medium described herein, receiving the report may include operations, features, means, or instructions for receiving the report including an indication of the level of correlation for a top number of beam pairs associated with a highest level of correlation.

In some examples of the method, apparatuses, and non-transitory computer-readable medium described herein, the level of correlation includes a resource index associated with the first resource set or the second resource set for each of the top number of beam pairs.

In some examples of the method, apparatuses, and non-transitory computer-readable medium described herein, the report includes a measured level of correlation between the individual beams in each pair.

In some examples of the method, apparatuses, and non-transitory computer-readable medium described herein, receiving the indication of the set of multiple beams may include operations, features, means, or instructions for receiving a measurement associated with each of the set of multiple beams.

### BRIEF DESCRIPTION OF THE DRAWINGS

FIG. 1 illustrates an example of a wireless communications system that supports techniques for configuring communications associated with reconfigurable intelligent surfaces (RISs) in accordance with aspects of the present disclosure.

FIG. 2 illustrates an example of a wireless communications system that supports techniques for configuring communications associated with RISs in accordance with aspects of the present disclosure.

FIG. 3 illustrates an example of a process flow that supports techniques for configuring communications associated with RISs in accordance with aspects of the present disclosure.

FIGS. 4 and 5 show block diagrams of devices that support techniques for configuring communications associated with RISs in accordance with aspects of the present disclosure.

FIG. 6 shows a block diagram of a communications manager that supports techniques for configuring communications associated with RISs in accordance with aspects of the present disclosure.

FIG. 7 shows a diagram of a system including a device that supports techniques for configuring communications associated with RISs in accordance with aspects of the present disclosure.

FIGS. 8 and 9 show block diagrams of devices that support techniques for configuring communications associated with RISs in accordance with aspects of the present disclosure.

FIG. 10 shows a block diagram of a communications manager that supports techniques for configuring communications associated with RISs in accordance with aspects of the present disclosure.

FIG. 11 shows a diagram of a system including a device that supports techniques for configuring communications associated with RISs in accordance with aspects of the present disclosure.

FIGS. 12 through 15 show flowcharts illustrating methods that support techniques for configuring communications associated with RISs in accordance with aspects of the present disclosure.

### DETAILED DESCRIPTION

In some wireless communications systems (e.g., systems implementing a massive multiple input-multiple output (MIMO) communication scheme), wireless devices may implement spatial division multiple access (SDMA) to increase signaling throughput. For example, a base station may use beamforming techniques to communicate with multiple user equipments (UEs) concurrently by using spatial dimensions provided by an environment. However, in some cases, physical proximity or environmental factors (e.g., interference, blockage) may impair beamforming communications between the base station and the multiple UEs. In some cases, wireless devices may be unable to successfully transmit information via a line-of-sight (LOS) path. For example, an LOS path (e.g., a straight line) between a base station and a UE may be obstructed. To overcome such impairments, the base station may employ an active antenna unit (AAU) to act as a relay between the base station and the multiple UEs. The AAU may include one or more antenna ports, radio frequency (RF) chains, and power amplifiers. The AAU may allow the base station to increase spatial diversity, beamforming gain, and cell coverage. For example, the AAU may receive a beamformed communication from the base station, amplify the beamformed communication, and re-transmit the beamformed communication to a UE. As such, in comparison to receiving the beamformed communication directly from the base station, the UE may have a higher likelihood of successfully receiving the beamformed communication via the AAU. However, active components (e.g., RF chains, power amplifiers) used by the AAU to amplify signals may be associated with increased power consumption. For example, a power amplifier at the AAU may utilize significant power overhead to amplify and re-transmit a received signal. Such power overhead may be undesirable and inefficient in some systems.

In some examples, the base station may employ a reconfigurable intelligent surface (RIS) (e.g., a reconfigurable reflective surface) that uses passive components (e.g., capacitors, resistors) to reflect incoming signals in one or more directions with a reduced power overhead. For example, the RIS may use a capacitor and a resistor to reflect a signal in a specific direction (e.g., instead of using a power amplifier to amplify and re-transmit the signal). As such, the RIS may increase cell coverage, spatial diversity, and beamforming gain while consuming less power than an AAU. In some aspects, the base station may dynamically configure the RIS to reflect an incoming signal in a specific direction. For example, the base station may configure the RIS to reflect a beamformed communication in a direction of a UE based on a location of the UE. Similarly, the UE may transmit a beamformed communication in a direction of the RIS based on a base station configuration or a UE selection. To effectively implement the RIS, the base station may indicate configuration information for the RIS to the UE. The configuration information may include a location of the RIS, an uplink reflection angle of the RIS, a downlink reflection angle of the RIS, or a combination thereof. In some examples, the base station may transmit, to the UE (e.g., via a RIS), configuration information for multiple RISs in a coverage area of the base station that the UE may use to communicate with the base station via a RIS.

A RIS may be capable of reflecting one beamformed signal at a time or may be capable of reflecting multiple beamformed signals concurrently. Additionally or alternatively, a base station may utilize a single RIS or may use a combination of multiple RISs to reflect multiple beamformed signals (e.g., concurrently). If a RIS does not support concurrently reflecting multiple beams, a base station may transmit information to the RIS using a single beam, and the RIS may reflect the beam at varying angles at different times (e.g., the RIS may perform a beam sweep) based on different configurations of the RIS elements at the different times. In some cases, a link between a base station and a RIS may be LoS such that the base station transmits a beam directly to the RIS. If a base station-RIS link is LoS, then the link may be used to serve one UE, in some cases. In some other cases, a link between the base station and a RIS may be non-LoS in which the base station may direct a beam in the direction of a reflective object (e.g., an object in nature such as a building, vehicle, etc.) and the reflective object may reflect the beam toward the intended RIS. Utilizing such non-LoS techniques to reach a RIS may provide a base station with multiple pathways to reach a RIS and allow the base station to use a single RIS to reach multiple UEs. Accordingly, a base station may communicate with one or more UEs via one or more RISs. In some cases, beamformed communications reflected by a RIS may be referred to as RIS-aided communications or RIS-aided transmissions.

In some cases, UEs served by the base station may be partitioned across different RISs, so that a first RIS may serve a first set of UEs, and a second RIS may serve a second set of UEs. Each RIS may perform communications with each UE for which the RIS serves. In such cases, a RIS may not account for other UEs for which the RIS does not serve. For example, when configuring communications with the first set of UEs, the first RIS may not consider the second set of UEs, the second RIS, or a combination thereof. As a result, multiple RISs may transmit signals that may interfere with signals from other RISs. As such, the intended receiver of the signals may be unable to successfully decode the signals because of the interference. Additionally or alternatively, such partitioning of sets of UEs to RISs may result in rank limitations, introduce complexity and latency associated with UE mobility, and result in increased load balancing complexity.

To improve communications between a base station and one or more UEs via RISs, a base station may request one or more UEs to indicate a correlation of beams from a first RIS to beams of one or more other RISs. Accordingly, the base station may configure communications via different RISs such that the transmissions from one RIS do not interfere with the transmissions from another RIS. For example, a base station may configure multiple RISs to perform beam sweeping. A UE may receive reference signals over multiple beams from one or more RISs and the UE may report back to the base station a set of strong beams. The base station may determine if the set of strong beams is associated with multiple RISs. If so, the base station may configure multiple resource sets, one for each RIS that has a beam included in the set of strong beams. Each RIS may then transmit a reference signal over each of the reported strong beams and the UE may perform channel estimation for each of the beams. The UE may then determine a level of correlation (e.g., association, incompatibility) between the strong beams of a first RIS with beams of another RIS and the UE may report an indication of the correlation. The base station may then configure the RISs to transmit over beams so as to reduce interference based on the correlations.

Particular aspects of the subject matter described herein may be implemented to realize one or more advantages. The described techniques may support improvements in configuring communications via RISs by improving reliability, and decreasing latency among other advantages. As such, supported techniques may include improved network operations and, in some examples, may promote network efficiencies, among other benefits.

Aspects of the disclosure are initially described in the context of wireless communications systems. Aspects are then described with reference to a process flow. Aspects of the disclosure are further illustrated by and described with reference to apparatus diagrams, system diagrams, and flowcharts that relate to techniques for configuring communications associated with RISs.

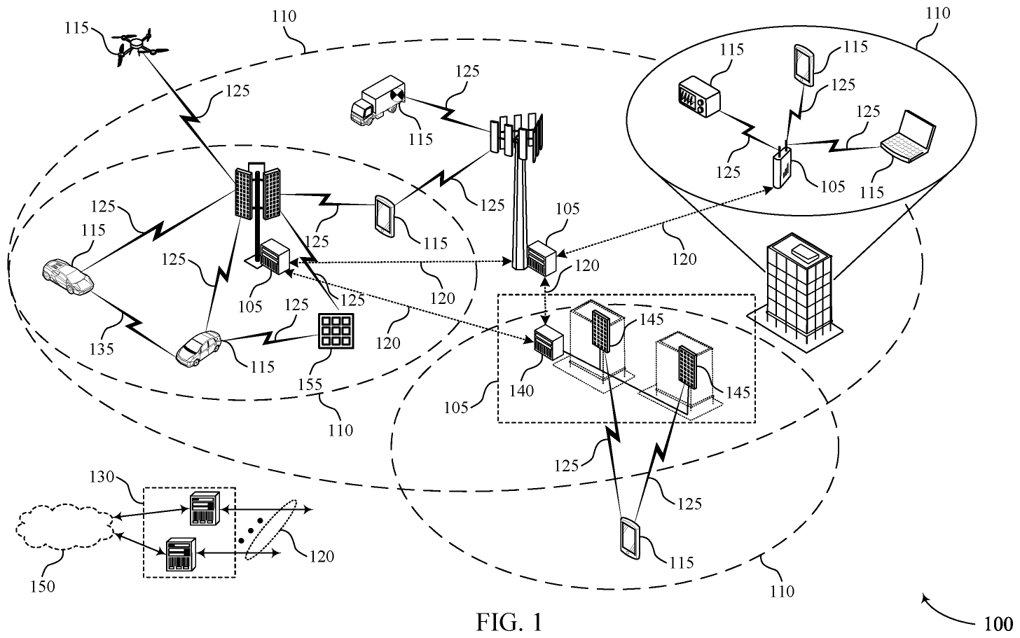

FIG. 1 illustrates an example of a wireless communications system 100 that supports techniques for configuring communications associated with RISs in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Various aspects of the present disclosure relate to improved techniques for configuring communications via RISs 155. For example, the wireless communications system 100 may include one or more RISs 155. A RIS 155 may reflect a beamformed transmission for improved spatial diversity. For example, if there is an obstruction between a base station 105 and a UE 115, beamformed communications between the base station 105 and the UE 115 may be blocked (or otherwise result in relatively poor signal quality) due to the obstruction. A RIS 155 may support communications between the base station 105 and the UE 115 by reflecting beamformed communications so as to avoid the obstruction. RISs 155 may provide additional spatial diversity for communications while operating according to relatively low power overheads (e.g., below a threshold power level).

In some examples, a UE 115 may transmit, to a base station 105, an indication of a plurality of beams on which the UE 115 receives a signal from the base station 105 (e.g., directly, or via a RIS 155). The UE 115 may receive, based on transmitting the indication, a message indicating at least a first resource set associated with one or more first beams from the plurality of beams and a second resource set associated with one or more second beams from the plurality of beams. The UE 115 may transmit a report indicative of a level of correlation between pairs of individual beams, each pair including a first individual beam of the one or more first beams and a second individual beam of the one or more second beams. The UE 115 may communicate with the base station 105 via a selected beam of the one or more first beams or the one or more second beams based on transmitting the report.

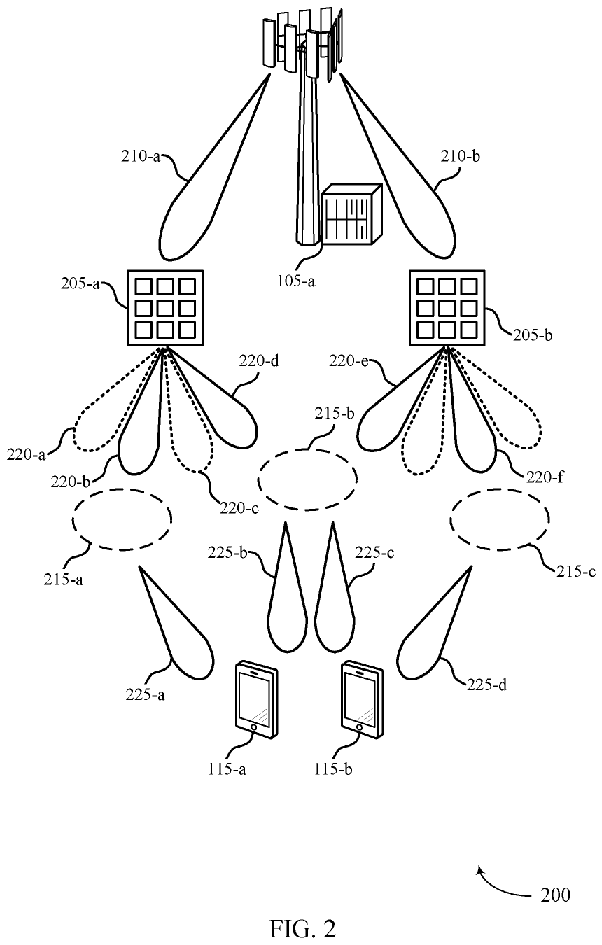

FIG. 2 illustrates an example of a wireless communications system 200 that supports techniques for configuring communications associated with RISs in accordance with aspects of the present disclosure. The wireless communications system 200 may include base station 105-a, UEs 115-a and 115-b, and RISs 205-a and 205-b, which may be examples of a base station 105, UEs 115, and RISs 155 as described with reference to FIG. 1. In some cases, base station 105-a may implement a beam correlation procedure for determining a level of correlation between beams associated with different RISs 205. Additionally or alternatively, other wireless devices, such as UEs 115-a, and 115-b, or some combination of these UEs 115, may implement a beam correlation procedure.

Base station 105-a may serve multiple UEs 115 and in some examples, base station 105-a may transmit information to one or more UEs 115 using beamformed communications (e.g., messages sent using beams 210). In some examples, physical proximity, environmental factors (e.g., interference from other devices, blockages due to obstructions), or power constraints may impair beamformed communications between base station 105-a and a UE 115. In some examples, base station 105-a may be unable to successfully transmit information to a UE 115 via an LOS path. For example, base station 105-a may be unable to transmit information directly to UEs 115-a and 115-b via an LOS path, for example, due to interference from one or more other devices, due to a power constraint at base station 105-a, due to an obstruction-such as a building-between base station 105-a and UE 115-c, due to a physical distance between base station 105-a and the UEs 115, or due to any other factors affecting signal quality between base station 105-a and the UEs 115. In some such examples, base station 105-a may transmit information to UE 115-c by reflecting a transmission off of a reflective or semi-reflective surface, which may allow the transmission to reduce interference, avoid an obstruction, or otherwise improve the signal quality of the transmission between base station 105-a and the UEs 115-c.

In some examples, the wireless communications system 200 may include one or more RISs 205 to facilitate transmissions between wireless devices. For example, a RIS 205 may facilitate the transmission of beamformed communications between base station 105-a and UEs 115-a and 115-b. In some examples, RISs 205 may be deployed in cellular systems including LTE, 5G NR, and other cellular systems. A RIS 205 may include a quantity of reflective, electrically-controllable elements. Each element may have electromagnetic characteristics that are reconfigurable and that define how beamformed communications reflect off the element. For example, a reflection coefficient of a reflective element may determine a reflection angle (e.g., based on an angle of incidence) for an incoming signal and may be reconfigurable by the RIS 205 or by the wireless network (e.g., via control signaling by a base station 105, such as base station 105-a). In some examples, the reflective elements may be uniformly distributed. The RIS 205 may reflect transmissions in a specific direction (e.g., in a controlled manner) based on a combination of configured states of reflective elements. For example, RIS 205-a may receive a beamformed transmission from base station 105-a using beam 210-a at an angle of incidence and may reflect the beamformed transmission at a different angle according to a current configuration of RIS 205-a (or a current configuration of one or more specific elements of the RIS 205). The RIS 205 may alter one or more channel realizations in a controlled manner, which may enhance channel diversities. For example, the RIS 205 may alter a channel realization for a channel by changing a reflection angle and—accordingly—changing the channel quality, signal quality, signal direction, or a combination thereof for communications on the channel. Increased channel diversity (e.g., increased spatial diversity based on different beam 210 reflections and directions) may provide robustness to channel blocking and channel fading, which may provide advantages in the wireless communications system 200.

In some cases, a RIS 205 may be self-contained (e.g., the RIS 205 may be a standalone RIS) or may be associated with (e.g., paired with) some other wireless device (e.g., a RIS-enabled UE). In some examples, the RIS 205 may be capable of configuring a reflected beam direction and a reflected beam width, among other capabilities. The reflected beam direction, reflected beam width, or both may be based on the incoming beam direction (e.g., the direction of beams 210-a and 210-b), the incoming beam width (e.g., the width of beams 210-a and 210-b), or both.

In some examples, a RIS 205 may be capable of reflecting one beam 210 at a time or may be capable of reflecting multiple beams 210 concurrently. Base station 105-a may transmit signals to RIS 205-a using a single beam 210-a, and RIS 205-a may reflect the signals at varying angles at different time instances (e.g., RIS 205-a may perform a beam sweep). Similarly, base station 105-a may transmit signals to RIS 205-b using a single beam 210-b, and RIS 205-b may reflect the signals at varying angles at different time instances (e.g., RIS 205-b may perform a beam sweep). For example, RIS 205-a may reconfigure one or more RIS elements such that RIS 205-a reflects beam 210-a as beam 220-a at a first time period, as beam 220-b at a second time period, as beam 220-c at a third time period, and as beam 220-d at a fourth time period. Accordingly, a UE 115 may detect different reflected beams 220 at different times.

In some cases, a base station may rely on multiple RISs 205 to provide communications to one or more UEs 115. The one or more UEs 115 may be partitioned among the multiple RISs, so that one UE 115 is served by one RIS 205 at a time. For example, UE 115-a may be assigned to RIS 205-a and UE 115-b may be assigned to RIS 205-b. Each RIS 205 may perform communications with each UE 115 for which the RIS 205 serves. In such cases, a RIS 205 may not account for other UEs 115 for which the RIS 205 does not serve. For example, when configuring communications with UE 115-a, RIS 205-a may not consider UE 115-b, RIS 205-b, or a combination thereof. As a result, multiple RISs 205 may transmit signals that may interfere with signals from other RISs 205. For example, RIS 205-a may transmit a signal over beam 220-d intended for UE 115-a, and RIS 205-b may transmit a signal over beam 220-e intended for UE 115-b. In some cases, beams 220-d and 220-e may reach reflective object 215-a (e.g., an object in the environment such as a building, a vehicle) prior to reaching UEs 115-a, and 115-b, respectively. In some cases, the RISs 205 may have accounted for the reflective object 215-b when configuring beams 220-d and 220-e to communicate with UEs 115-a, and 115-b, respectively. The reflective object 215-b may reflect beam 220-d to produce beam 225-b directed to UE 115-a and may reflect beam 220-e to produce beam 225-c directed to UE 115-b. However, as UE 115-a and 115-b are relatively close to one another and beams 225-b and 225-c are associated with the same starting location (e.g., reflective object 215-b), then UEs 115-a and 115-b may both receive beams 225-b and 225-c. If beams 225-b and 225-b are transmitted in the same or similar time and frequency resources, then UEs 115-a and 115-b may be unable to differentiate the beams 225 because the beams 225 are directed from the same starting point. Accordingly, UE 115-a may be unable to successfully decode the signal associated with beam 225-b and UE 115-b may be unable to successfully decode the signal associated with beam 225-c due to the interference.

Additionally or alternatively, such partitioning of sets of UEs 115 to RISs 205 may result in rank limitations, introduce complexity and latency associated with UE mobility, and result in increased load balancing complexity. For example, in the case of rank limitations, spatial diversity generally improves if multiple RISs 205 serve the same UE 115, simultaneously. Accordingly, if UEs 115 are partitioned to only be served by one RIS 205 at a time, then the spatial diversity and rank may be limited. In an example, of mobility complexity, a RIS 205 may serve a relatively small area. Accordingly, UEs 115 may frequently move out of the serving area of one RIS 205 and into the serving area of another RIS 205. If UEs 115 are configured to be served by only one RIS 205 at a time, then each time the UE 115 moves out of one RIS serving area and into another, the UE 115 may perform a handover procedure. As such, such partitioning may introduce complexity and latency to communications during UE mobility. In an example of load balancing, if one RIS 205 becomes overloaded, one or more UEs 115 may be directed to move to a different, non-overloaded RIS 205. However, to move to another RIS 205, the UEs 115 may perform a handover procedure. As such, such partitioning may introduce complexity and latency in performing load balancing.

To improve communications between a base station 105 and one or more UEs 115 via RISs 205, a base station 105 may flexibly partition UEs 115 (e.g., soft partitioning) across one or more RISs 205. In some cases, flexible partitioning may refer to a RIS-UE association (e.g., partition) being limited to a physical layer rather than a medium access control (MAC) layer. With such flexible partitioning, communications across multiple RISs 205 may be considered so as to reduce interference and in some cases, multiple RISs 205 may serve one UE 115. For example, rather than maximizing signal strength between a RIS 205 and an intended UE 115 (e.g., for all cases, which may result in interference), the base station 105 and RISs 205 may instead prioritize signal quality (e.g., SINR) enhancement across UEs 115 served by the base station 105. In some cases, the base station 105 and RISs 205 balance signal strength and signal quality to provide reliable communications throughout the network.

To enable flexible partitioning, a base station 105 may partition sets of UEs 115 to different RISs 205. For example, base station 105-a may partition UE 115-a to RIS 205-a and partition UE 115-b to RIS 205-b. Base station 105-a may then configure multiple RISs 205, such as RISs 205-a and 205-b, to perform beam sweeping, such that each RIS 205 may transmit a signal (e.g., a reference signal) using multiple beams. For example, base station 105-a may transmit a beam 210 including the signal, such as a reference signal (e.g., CSI-RS), to each RIS 205, and each RIS 205 may reflect the beam in multiple directions, in a beam sweeping manner. Base station 105-a may transmit beam 210-a to RIS 205-a and transmit beam 210-b to RIS 205-b. Upon receiving beam 210-a, RIS 205-a may beam sweep the reference signal over beams 220-a, 220-b 220-c, and 220-d, for example. Similarly, upon receiving beam 210-b, RIS 205-b may beam sweep the reference signal over a set of beams 220.

In some cases, a UE 115 may receive a signal directly from a RIS 205. For example, UE 115-a may receive a reference signal via beam 220-c, directly from RIS 205-a. In some cases, a UE 115 may receive a signal that has reflected off a reflective object 215 that is between the UE 115 and a RIS 205. For example, UE 115-a may receive a reference signal from RIS 205-a over beam 225-a via reflective object 215-a and over beam 225-b via reflective object 215-b. UE 115-a may receive reference signals (e.g., CSI-RSs) from base station 105-a via one or more beams 220, where the one or more beams 220 may originate from one RIS 205, or from multiple RISs 205. For example, UE 115-a may additionally receive a reference signal via beam 225-c, where beam 225-c is associated with RIS 205-b. Accordingly, UE 115-a may receive reference signals via multiple RISs 205. However, UE 115-a may not be aware that UE 115-a received reference signals via multiple RISs 205. For example, UE 115-a may just acknowledge that UE 115-a received reference signals via multiple beams 225. Similarly, UE 115-b may receive reference signals (e.g., CSI-RSs) from base station 105-a via one or more beams 220, where the one or more beams 220 may originate from one RIS 205, or from multiple RISs 205. For example, UE 115-b may receive a reference signal over at least beam 225-c via reflective object 215-b, over beam 225-d via reflective object 215-c, and via beam 225-b. Accordingly UE 115-b may receive reference signals via RIS 205-a and 205-b. UE 115-a and UE 115-b may each receive a reference signals from multiple RISs 205 due to the common reflection of beams 225-b md 225-c off of reflective object 215-b.

Upon receiving one or more reference signals, each UE 115 may be configured to perform one or more measurements based on the received reference signals and to transmit a report back to base station 105-a. For example, UE 115-a may measure reference signal received power (RSRP) for at least the reference signal received over beam 225-a, the reference signal received over beam 225-b, and for the reference signal received over beam 225-c. Additionally or alternatively, UE 115-a may measure other channel or signal metrics for the received reference signals. In some cases, UE 115-a may determine a set of strong beams (e.g., preferred beams) based on the measurements, such as the beams associated with the strongest measurements (e.g., RSRP). For example, UE 115-b may rank the beams based on the measurements and determine the set of strong beams based on the ranking. The UE 115 may be configured to identify a certain number of strong beams, such as the top three beams associated with the strongest measurements. In some cases, the UE 115 may be configured to include the beams associated with a measurement above a threshold in the set of strong beams. For example, the UE 115 may be configured (e.g., receive an indication, be preconfigured) or otherwise determine a threshold for comparing the reference signal measurements to and the UE 115 may include each beam associated with a measurement that meets the threshold in the set of strong beams. UE 115-a may be unaware that one or more of the determined strong beams are associated with different RISs. For example, a UE 115 may be unable to associate a beam to the device that transmitted the beam. In some cases, UE 115-a may be configured to transmit a report to base station 105-a directly, or via an RIS 205. The report may indicate the set of strong beams, such as by an identifier (e.g., index) associated with each beam of the set. Additionally or alternatively, the report may indicate the measurements of all or a subset the beams over which UE 115-a received a reference signal, such as the measurements of the set of strong beams. UE 115-b may perform a same or similar procedure for each received reference signal.

Upon receiving a report from a UE 115, base station 105-a may determine whether the UE 115 is experiencing strong beams from multiple RISs 205. For example, if the UE 115 transmits a report including the measurements for all the beams over which the UE 115 received a reference, the base station 105, may compare each measurement to a threshold. If a measurement meets the threshold, then the base station 105 may determine that the beam associated with the measurement is considered a strong beam at the UE 115. The base station 105 may then analyze the strong beams to determine the source (e.g., RIS 205) of the beam. In some other cases, if the report includes an indication of a set of strong beams, then the base station 105 may then analyze the strong beams to determine the source of the beam based on the report. If base station 105-a determines that the UE 115 is experiencing strong beams from multiple RISs 205, base station 105-a may prompt the UE 115 to perform a beam correlation determination procedure.

For example, base station 105-a may receive a report from UE 115-a, where the report may indicate beams 225-a, 225-b and 225-c as strong beams to UE 115-a. Base station 105-a may determine that beams 225-a and 225-b are associated with RIS 205-a, as beams 225-a and 225-b are associated with beams 220-b and 220-d, respectively, from RIS 205-a. Base station 105-a may also determine that beam 225-c is associated with RIS 205-b, as beam 225-c is associated with beam 220-e from RIS 205-a. Accordingly, base station 105-a may prompt the beam correlation determination procedure (e.g., a multi-RIS optimization algorithm). To begin the beam correlation procedure, base station 105-a may configure multiple resource sets, one for each RIS 205 associated with the report. The size of each resource set may be based on the number of strong beams reported by the UE 115 that correspond to that RIS 205. Accordingly, base station 105-a may configure resource sets of different sizes. For example, base station 105-a may configure a first resource set associated with RIS 205-a, where the size of the first resource set is based on strong beam 225-a and 225-b. Base station 105-a may also configure a second resource set associated with RIS 205-b, where the size of the second resource set is based on strong beam 225-c. Base station 105-a may transmit an indication of the first resource set and the second resource set to UE 115-a (e.g., directly, or via RIS 205-a). The indication may include an association of each strong beam to a resource set, or a RIS 205, or a combination thereof. For example, UE 115-a may receive an indication of a first resource set, and that one or more resources of the first resource set is associated with beam 225-a (e.g., and/or RIS 205-a), and one or more of the resources of the first resource set is associated with beam 225-b (e.g., and/or RIS 205-a). UE 115-a may also receive an indication of a second resource set, and that one or more of the resources of the second resource set is associated with beam 225-c (e.g., and/or RIS 205-b). Accordingly, UE 115-a may identify which strong beam is associated with which RIS 205.

Upon receiving the indication of the resource sets, UE 115 may monitor for one or more signals transmitted via the strong beams. Base station 105-a may transmit a signal (e.g., a reference signal) to each of the RISs 205 involved in the report (e.g., RIS 205-a, and RIS 205-b), and the RISs 205 may be configured to relay the signal to UE 115-a over each of the beams indicated as strong beams in the report. Base station 105-a may transmit the signals via beams 210-a and 210-b at the same time, or at different times. For example, RIS 205-a may receive the signal from base station 105-a via beam 210-a and may relay the signal via strong beams 220-b and 220-d. RIS 205-b may receive the signal from base station 105-a via beam 210-b and may relay the signal via strong beam 220-e.

UE 115-a may receive the signal via some combination of strong beams 225-a, 225-b, and 225-c. UE 115-a may receive the signals via beams 225-a, 225-b, and 225-c in accordance with the indicated resource sets. Upon receiving the signals via beams 225-a, 225-b, and 225-c, and in line with the beam correlation procedure, UE 115-a may be configured to perform a channel estimation procedure for each of the strong beams. For example, UE 115-a may estimate a channel associated with beam 225-a (H1), estimate a channel associated with beam 225-b (H2), and estimate a channel associated with beam 225-c (G1).

Upon estimating the channels for each of the strong beams, UE 115-a may measure a level of correlation of beams across different resource sets (e.g., across different RISs 205) based on the channels. Accordingly, UE 115-a may determine a level of correlation between H1 and G1 (e.g., corr(H1, G1)), and between H2 and G1 (e.g., corr(H2, G1)). In some cases, UE 115-a may transmit a report to base station 105-a indicating the determined correlations, directly or indirectly via RIS 205-a. For example, the report may include corr(H1, G1) and corr(H2, G1). In some cases, UE 115-a may be configured to compare each correlation to a threshold. If a correlation meets the threshold, then UE 115-a may report the measured correlation or otherwise indicate the undesired beam pair.

In some cases, UE 115-a may be configured to sort (e.g., rank) the correlations from highest to lowest correlation. Accordingly, UE 115-a may determine that corr(H2, G1) is associated with the highest correlation and corr(H1, G1) is associated with the lowest correlation. In some cases, UE 115-a may assign indices (e.g., identifiers) for each correlation based on the ranking. UE 115-a may be configured to report the correlations based on the ranking. UE 115-a may report a top, N, number of correlations. For example, UE 115-a may report the top, N, correlation measurements, the top, N, indices that correspond to the top, N, correlations, or a combination thereof. For example, N may be equal to one and UE 115-a may report (H2, G1) (e.g., an index), report corr(H2, G1) (e.g., a measurement), or a combination thereof, because the correlation between H2 and G1 is stronger than the correlation between H1 and G1. The configuration of the report may be updated aperiodically, semi-statically, or dynamically. For example, the configuration of the report (e.g., the information included in the report) may be based on the number and/or level of correlations the UE 115 determined. For example, if the UE 115-a has a large number of correlations to report, the UE 115-a may include less information associated with each correlation. For example, UE 115-a may include an index associated with each correlation, but not the correlation measurements.

Accordingly, UE 115-a may report indications of undesired beams pairs, where an undesired beam pair may include an intended strong beam from a serving RIS 205 (e.g., beam 225-a, and 225-c from serving RIS 205-a) and an interfering strong beam from a non-serving RIS 205 that is highly correlated with the intended strong beam (e.g., beam 225-c associated with non-serving RIS 205-b).

The base station 105 may use the beam correlations to configure communications via different RISs 205 such that the transmissions from one RIS 205 do not interfere with the transmissions from another RIS 205. In some cases, base station 105-a may jointly configure the multiple RISs 205 based on one or more reports from multiple UEs 115. For example, if base station 105-a determines to configure RIS 205-a with beam 220-d (e.g., beam 225-b) to communicate with UE 115-a, the base station 105-a may refrain from configuring RIS 205-a with beam 220-e (e.g., beam 225-c) due to the high level of correlation between beams 225-b and 225-c. In some cases, base station 105-a may avoid using beams 220-d, and 220-e (e.g., beam 225-b, and beam 225-c, respectively) as long as there is a high level of correlation between the beams. For example, base station 105-a may configure RIS 205-a to use beam 220-b to communicate with UE 115-a (e.g., a strong beam with a low level of correlation with any beams from another RIS 205) and configure RIS 205-b to use beam 220-f to communicate with UE 115-b (e.g., a strong beam with a low level of correlation with any beams from another RIS 205).

In some implementations, base station 105-a may ban (e.g., prohibit) the use of one or more beams. For example, if a beam is reported as being highly correlated with multiple beams impacting one or more UEs 115, RISs, or a combination thereof, then the base station 105 may ban the use of that beam. In another example, if the beam is reported frequently as being highly correlated with one or more other beams, then the base station 105 may ban the use of the beam. The base station 105 may ban the beam permanently, or a for a duration of time. To ban a beam, base station 105-a may transmit an indication to a RIS 205 indicating the banned beam. For example, the indication may include an identifier associated with the banned beam.

A base station 105 may consider one or more parameters when configuring RIS 205. For example, the base station 105 may consider the reported reference signals measurements (e.g., RSRP), the reported strong beams, the level of correlations, etc. and the base station 105 may consider such parameters associated with multiple UE 115 and multiple RISs 205 to avoid interference between beams while maintaining performance and throughput associated with the network.

Accordingly, soft or flexible partitioning (e.g., partitioning in combination with consideration for surrounding environment) may allow for serving the same UE 115 with multiple RISs 205 to enhance spatial diversity and multi-RIS optimization (e.g., correlation determination) may mitigate the possibility of interference caused by multiple RISs 205.

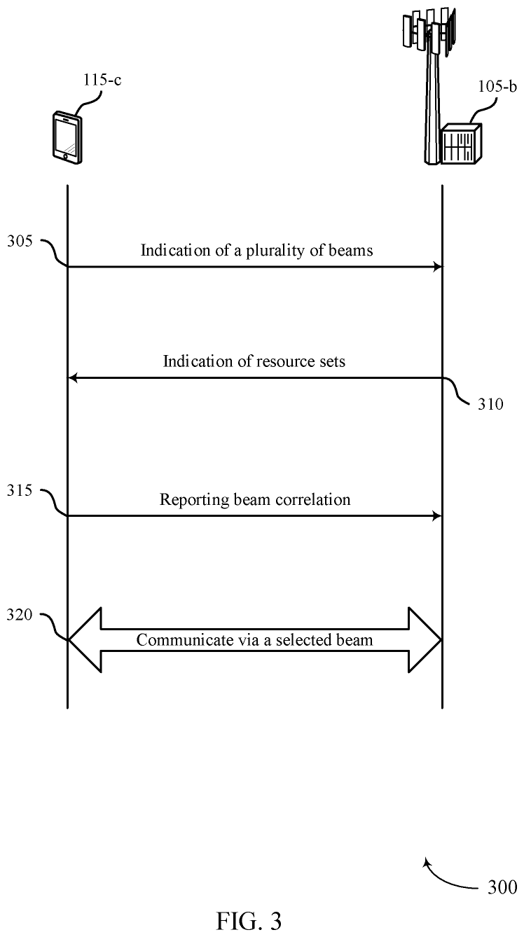

FIG. 3 illustrates an example of a process flow 300 that supports techniques for configuring communications associated with RISs in accordance with aspects of the present disclosure. The process flow 300 may illustrate an example beam correlation determination procedure for reducing interference between RISs. For example, base station 105-b may prompt UE 115-c to perform the beam correlation determination procedure which base station 105-b nay use the results of to configure communication with UE 115-c. Base station 105-b and UE 115-c may be examples of the corresponding wireless devices described with reference to FIGS. 1 and 2. In some cases, instead of base station 105-b and UE 115-c implementing the correlation determination procedure, a different type of device may perform a same or similar procedure. Alternative examples of the following may be implemented, where some steps are performed in a different order than described or are not performed at all. In some cases, steps may include additional features not mentioned below, or further steps may be added.

At 305, UE 115-c may transmit, to base station 105-b, an indication of a plurality of beams on which UE 115-c receives a signal from base station 105-b. In some cases, transmitting the indication of the plurality of beams may include measuring a plurality of signals received by the UE, where each signal of the plurality of signals may be received over a different beam of the plurality of beams, and transmitting the indication of the plurality of beams may be based on the measuring, where the plurality of beams may be associated with a number of strongest measured signals. In some cases, transmitting the indication of the plurality of beams may include transmitting a measurement associated with each of the plurality of beams based on UE 115-c receiving the signal from base station 105-b. Transmitting the indication of the plurality of beams may be based on the plurality of beams being associated with a measured signal greater than a threshold.

At 310, UE 115-c may receive, based on transmitting the indication, a message indicating at least a first resource set associated with one or more first beams from the plurality of beams and a second resource set associated with one or more second beams from the plurality of beams. The first resource set may be associated with a first RIS and the second resource set may be associated with a second RIS. A size of the first resource set may be based on the plurality of beams on which UE 115-c receives the signal via the first RIS and a size of the second resource set may be based on the plurality of beams on which UE 115-c receives the signal via the second RIS.

In some cases, base station 105-b may determine that the indication of the plurality of beams includes the one or more first beams associated with the first a RIS and includes the one or more second beams associated with the second RIS. Base station 105-b may determine the first resource set and the second resource set based on the indication of the plurality of beams including beams associated with different RISs. Determining the first resource set and the second resource set may include determining a size of the first resource set based on a number of beams included in the one or more first beams and a size of the second resource set based on a number of beams included in the one or more second beams.

In some cases, UE 115-c may receive a second signal via each of the one or more first beams and the one or more second beams in accordance with the first resource set and the second resource set, and perform channel estimation for each of the one or more first beams and the one or more second beams based on the received second signals. UE 115-c may determine the level of correlation between each pair based on the channel estimation of the one or more first beams and the one or more second beams.

In some cases, UE 115-c may rank levels of correlations for each pair from the highest level of correlation to a lowest level of correlation, where transmitting the report may be based on the ranking.

At 315, UE 115-c may transmit a report indicative of a level of correlation between pairs of individual beams, each pair including a first individual beam of the one or more first beams and a second individual beam of the one or more second beams. Transmitting the report may include transmitting the report including the indication of the level of correlation for a top number of beam pairs associated with a highest level of correlation. The indication of the level of correlation may include a pair of resource indices for each of the top number of beam pairs, such as a first resource index associated with the first resource set and a second resource index associated with the second resource set. In some implementations, the indication of the level of correlation may include a measured level of correlation.

In some cases, base station 105-b may receive a plurality of reports indicative of the level of correlation between pairs of individual beams, such as from UE 115-c, or from multiple UEs 115. Base station 105-b may identify one or more individual beams indicated in more than one of the plurality of reports, and determine to prohibit communications via the one or more individual beams based on the one or more individual beams being indicated in the more than one of the plurality of reports. In some implementations, base station 105-b may determine a RIS associated with the one or more individual beams, and transmit a message to the RIS prohibiting use of the one or more individual beams by the RIS.

At 320, UE 115-c may communicate with base station 105-b via a selected beam of the one or more first beams or the one or more second beams based on transmitting the report. Communicating with base station 105-b via the selected beam may include communicating with base station 105-b via the selected beam and the first RIS or the second RIS based on transmitting the report. In some cases, base station 105-b may select a beam to communicate with UE 115-c based on the report, where the selected beam is based on the selecting performed by base station 105-b.

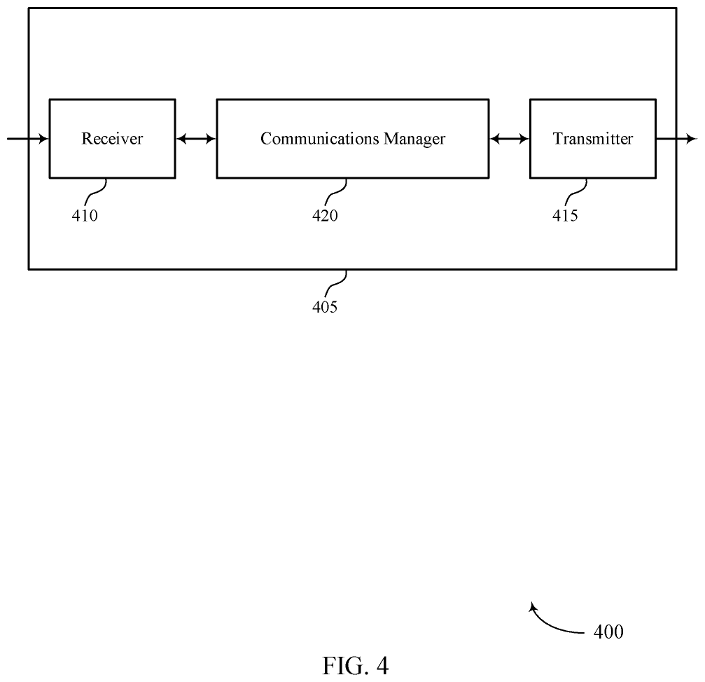

FIG. 4 shows a block diagram 400 of a device 405 that supports techniques for configuring communications associated with RISs in accordance with aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for configuring communications associated with RISs). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for configuring communications associated with RISs). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of techniques for configuring communications associated with RISs as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

The communications manager 420 may support wireless communications at a UE in accordance with examples as disclosed herein. For example, the communications manager 420 may be configured as or otherwise support a means for transmitting, to a base station, an indication of a set of multiple beams received by the UE. The communications manager 420 may be configured as or otherwise support a means for receiving, based on transmitting the indication, a message indicating at least a first resource set associated with one or more first beams from the set of multiple beams and a second resource set associated with one or more second beams from the set of multiple beams. The communications manager 420 may be configured as or otherwise support a means for transmitting a report indicative of a level of correlation between pairs of individual beams, each pair including a first individual beam of the one or more first beams and a second individual beam of the one or more second beams. The communications manager 420 may be configured as or otherwise support a means for communicating with the base station via a selected beam of the one or more first beams or the one or more second beams.

By including or configuring the communications manager 420 in accordance with examples as described herein, the device 405 (e.g., a processor controlling or otherwise coupled to the receiver 410, the transmitter 415, the communications manager 420, or a combination thereof) may support techniques for more efficient utilization of communication resources, and increased coordination in the network.

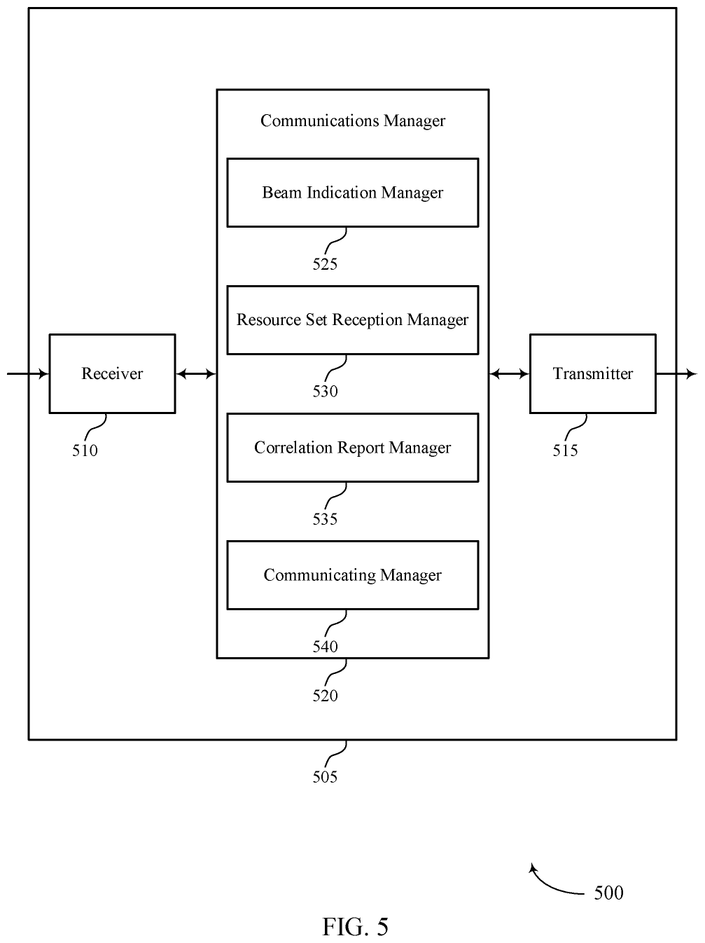

FIG. 5 shows a block diagram 500 of a device 505 that supports techniques for configuring communications associated with RISs in accordance with aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for configuring communications associated with RISs). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for configuring communications associated with RISs). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for configuring communications associated with RISs as described herein. For example, the communications manager 520 may include a beam indication manager 525, a resource set reception manager 530, a correlation report manager 535, a communicating manager 540, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a UE in accordance with examples as disclosed herein. The beam indication manager 525 may be configured as or otherwise support a means for transmitting, to a base station, an indication of a set of multiple beams received by the UE. The resource set reception manager 530 may be configured as or otherwise support a means for receiving, based on transmitting the indication, a message indicating at least a first resource set associated with one or more first beams from the set of multiple beams and a second resource set associated with one or more second beams from the set of multiple beams. The correlation report manager 535 may be configured as or otherwise support a means for transmitting a report indicative of a level of correlation between pairs of individual beams, each pair including a first individual beam of the one or more first beams and a second individual beam of the one or more second beams. The communicating manager 540 may be configured as or otherwise support a means for communicating with the base station via a selected beam of the one or more first beams or the one or more second beams.

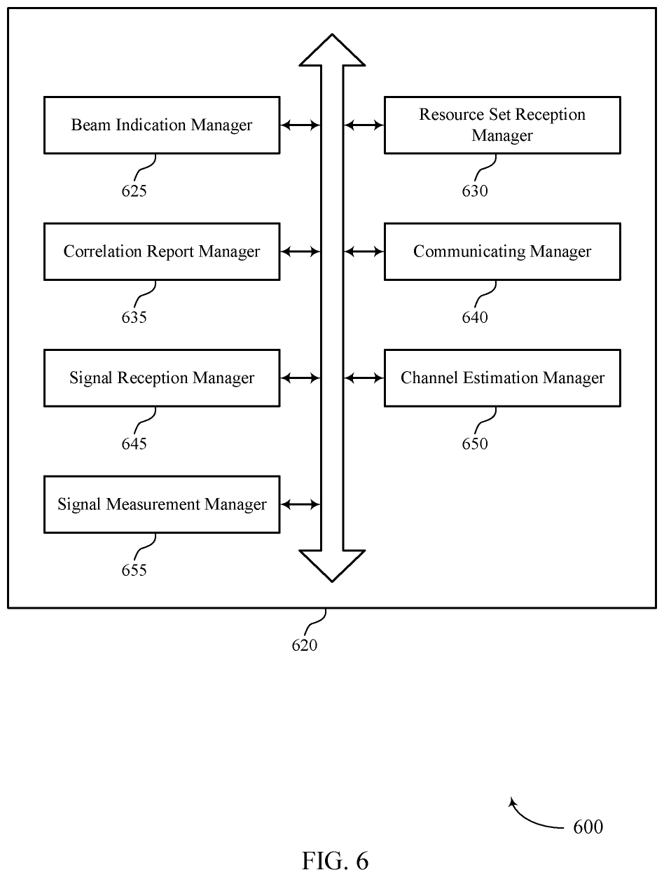

FIG. 6 shows a block diagram 600 of a communications manager 620 that supports techniques for configuring communications associated with RISs in accordance with aspects of the present disclosure. The communications manager 620 may be an example of aspects of a communications manager 420, a communications manager 520, or both, as described herein. The communications manager 620, or various components thereof, may be an example of means for performing various aspects of techniques for configuring communications associated with RISs as described herein. For example, the communications manager 620 may include a beam indication manager 625, a resource set reception manager 630, a correlation report manager 635, a communicating manager 640, a signal reception manager 645, a channel estimation manager 650, a signal measurement manager 655, or any combination thereof. Each of these components may communicate, directly or indirectly, with one another (e.g., via one or more buses).

The communications manager 620 may support wireless communications at a UE in accordance with examples as disclosed herein. The beam indication manager 625 may be configured as or otherwise support a means for transmitting, to a base station, an indication of a set of multiple beams received by the UE. The resource set reception manager 630 may be configured as or otherwise support a means for receiving, based on transmitting the indication, a message indicating at least a first resource set associated with one or more first beams from the set of multiple beams and a second resource set associated with one or more second beams from the set of multiple beams. The correlation report manager 635 may be configured as or otherwise support a means for transmitting a report indicative of a level of correlation between pairs of individual beams, each pair including a first individual beam of the one or more first beams and a second individual beam of the one or more second beams. The communicating manager 640 may be configured as or otherwise support a means for communicating with the base station via a selected beam of the one or more first beams or the one or more second beams.

In some examples, the signal reception manager 645 may be configured as or otherwise support a means for receiving a second signal via each of the one or more first beams and the one or more second beams in accordance with the first resource set and the second resource set. In some examples, the channel estimation manager 650 may be configured as or otherwise support a means for performing channel estimation for each of the one or more first beams and the one or more second beams based on the received second signals.

In some examples, the correlation report manager 635 may be configured as or otherwise support a means for determining the level of correlation between the individual beams in each pair based on the channel estimation of the one or more first beams and the one or more second beams.

In some examples, to support transmitting the report, the correlation report manager 635 may be configured as or otherwise support a means for transmitting the report including an indication of the level of correlation for a top number of beam pairs associated with a highest level of correlation.

In some examples, the level of correlation includes a pair of resource indices for each of the top number of beam pairs, a first resource index associated with the first resource set and a second resource index associated with the second resource set.

In some examples, the correlation report manager 635 may be configured as or otherwise support a means for ranking levels of correlations for each pair from the highest level of correlation to a lowest level of correlation, where the indication includes the ranked list.

In some examples, the report includes a measured level of correlation between the individual beams in each pair.

In some examples, to support transmitting the indication of the set of multiple beams, the signal measurement manager 655 may be configured as or otherwise support a means for measuring a set of multiple signals received by the UE, each signal of the set of multiple signals received over a different beam of the set of multiple beams. In some examples, to support transmitting the indication of the set of multiple beams, the beam indication manager 625 may be configured as or otherwise support a means for transmitting the indication of the set of multiple beams based on the measuring, the set of multiple beams associated with a number of strongest measured signals.

In some examples, to support transmitting the indication of the set of multiple beams, the beam indication manager 625 may be configured as or otherwise support a means for transmitting a measurement associated with each of the set of multiple beams.

In some examples, transmitting the indication of the set of multiple beams is based on the set of multiple beams being associated with a measured signal greater than a threshold.

In some examples, the first resource set is associated with a first RIS and the second resource set is associated with a second RIS.

In some examples, a size of the first resource set is based on the set of multiple beams received by the UE via the first RIS and a size of the second resource set is based on the set of multiple beams received by the UE via the second RIS.

In some examples, to support communicating with the base station via the selected beam, the communicating manager 640 may be configured as or otherwise support a means for communicating with the base station via the selected beam and the first RIS or the second RIS.

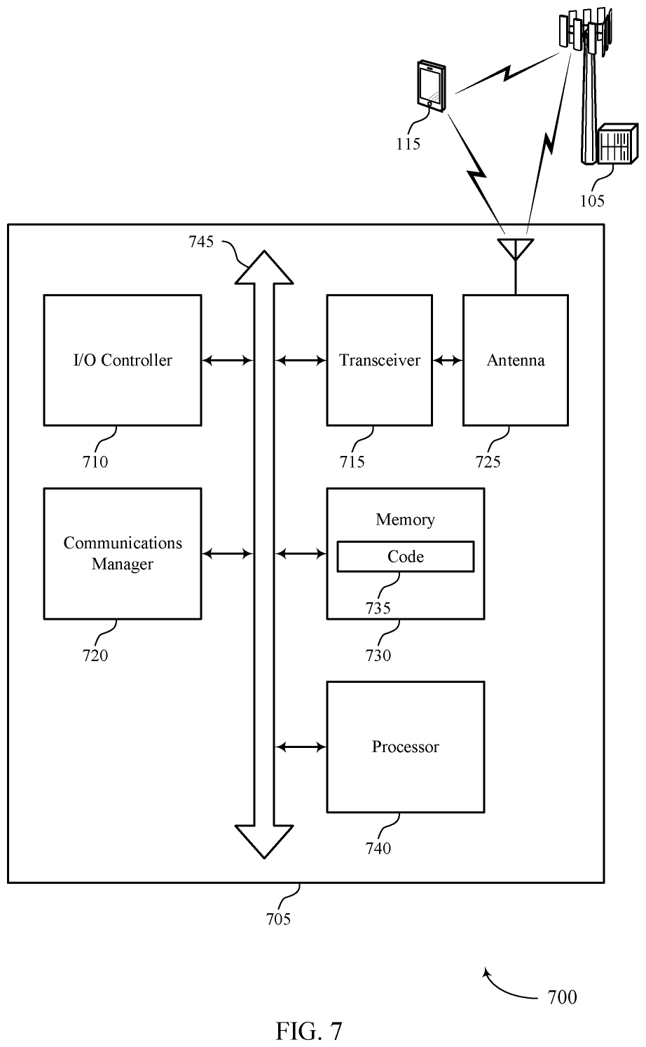

FIG. 7 shows a diagram of a system 700 including a device 705 that supports techniques for configuring communications associated with RISs in accordance with aspects of the present disclosure. The device 705 may be an example of or include the components of a device 405, a device 505, or a UE 115 as described herein. The device 705 may communicate wirelessly with one or more base stations 105, UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting techniques for configuring communications associated with RISs). For example, the device 705 or a component of the device 705 may include a processor 740 and memory 730 coupled to the processor 740, the processor 740 and memory 730 configured to perform various functions described herein.

The communications manager 720 may support wireless communications at a UE in accordance with examples as disclosed herein. For example, the communications manager 720 may be configured as or otherwise support a means for transmitting, to a base station, an indication of a set of multiple beams received by the UE. The communications manager 720 may be configured as or otherwise support a means for receiving, based on transmitting the indication, a message indicating at least a first resource set associated with one or more first beams from the set of multiple beams and a second resource set associated with one or more second beams from the set of multiple beams. The communications manager 720 may be configured as or otherwise support a means for transmitting a report indicative of a level of correlation between pairs of individual beams, each pair including a first individual beam of the one or more first beams and a second individual beam of the one or more second beams. The communications manager 720 may be configured as or otherwise support a means for communicating with the base station via a selected beam of the one or more first beams or the one or more second beams.

By including or configuring the communications manager 720 in accordance with examples as described herein, the device 705 may support techniques for improved communication reliability, reduced latency, more efficient utilization of communication resources, and improved coordination between devices.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of techniques for configuring communications associated with RISs as described herein, or the processor 740 and the memory 730 may be otherwise configured to perform or support such operations.

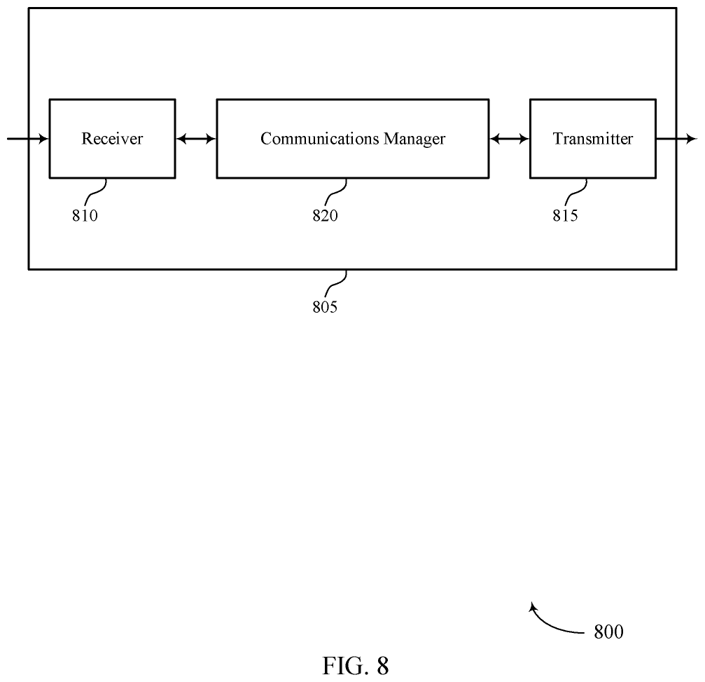

FIG. 8 shows a block diagram 800 of a device 805 that supports techniques for configuring communications associated with RISs in accordance with aspects of the present disclosure. The device 805 may be an example of aspects of a base station 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for configuring communications associated with RISs). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for configuring communications associated with RISs). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for configuring communications associated with RISs as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communications at a base station in accordance with examples as disclosed herein. For example, the communications manager 820 may be configured as or otherwise support a means for receiving, from a UE, an indication of a set of multiple beams received by the UE. The communications manager 820 may be configured as or otherwise support a means for transmitting, based on receiving the indication, a message indicating at least a first resource set associated with one or more first beams from the set of multiple beams and a second resource set associated with one or more second beams from the set of multiple beams. The communications manager 820 may be configured as or otherwise support a means for receiving a report indicative of a level of correlation between pairs of individual beams, each pair including a first individual beam of the one or more first beams and a second individual beam of the one or more second beams. The communications manager 820 may be configured as or otherwise support a means for communicating with the UE via a selected beam of the one or more first beams or the one or more second beams.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for more efficient utilization of communication resources.

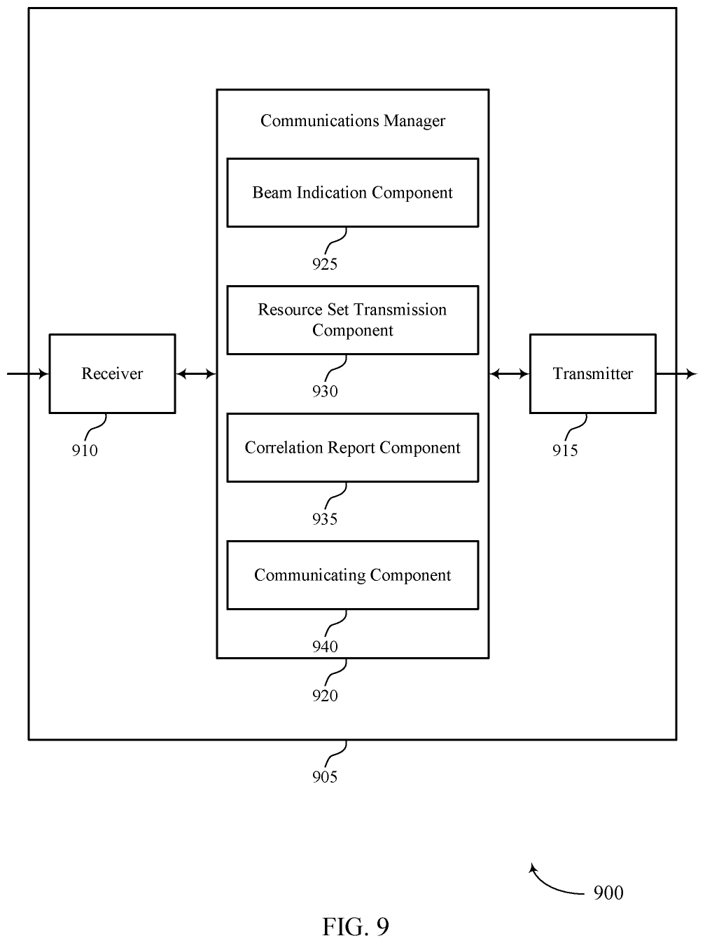

FIG. 9 shows a block diagram 900 of a device 905 that supports techniques for configuring communications associated with RISs in accordance with aspects of the present disclosure. The device 905 may be an example of aspects of a device 805 or a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for configuring communications associated with RISs). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for configuring communications associated with RISs). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for configuring communications associated with RISs as described herein. For example, the communications manager 920 may include a beam indication component 925, a resource set transmission component 930, a correlation report component 935, a communicating component 940, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a base station in accordance with examples as disclosed herein. The beam indication component 925 may be configured as or otherwise support a means for receiving, from a UE, an indication of a set of multiple beams received by the UE. The resource set transmission component 930 may be configured as or otherwise support a means for transmitting, based on receiving the indication, a message indicating at least a first resource set associated with one or more first beams from the set of multiple beams and a second resource set associated with one or more second beams from the set of multiple beams. The correlation report component 935 may be configured as or otherwise support a means for receiving a report indicative of a level of correlation between pairs of individual beams, each pair including a first individual beam of the one or more first beams and a second individual beam of the one or more second beams. The communicating component 940 may be configured as or otherwise support a means for communicating with the UE via a selected beam of the one or more first beams or the one or more second beams.

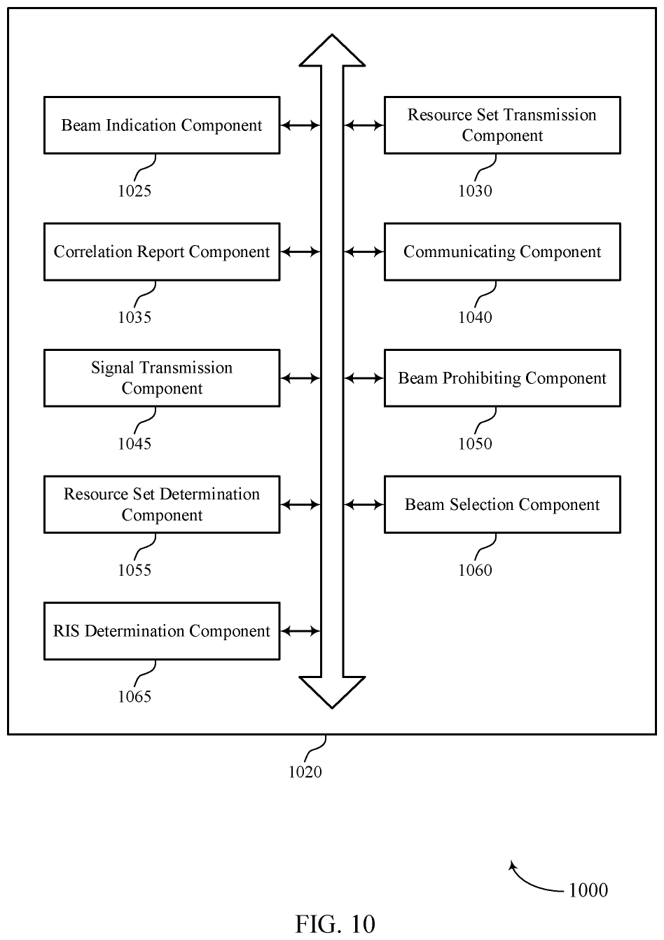

FIG. 10 shows a block diagram 1000 of a communications manager 1020 that supports techniques for configuring communications associated with RISs in accordance with aspects of the present disclosure. The communications manager 1020 may be an example of aspects of a communications manager 820, a communications manager 920, or both, as described herein. The communications manager 1020, or various components thereof, may be an example of means for performing various aspects of techniques for configuring communications associated with RISs as described herein. For example, the communications manager 1020 may include a beam indication component 1025, a resource set transmission component 1030, a correlation report component 1035, a communicating component 1040, a signal transmission component 1045, a beam prohibiting component 1050, a resource set determination component 1055, a beam selection component 1060, a RIS determination component 1065, or any combination thereof. Each of these components may communicate, directly or indirectly, with one another (e.g., via one or more buses).

The communications manager 1020 may support wireless communications at a base station in accordance with examples as disclosed herein. The beam indication component 1025 may be configured as or otherwise support a means for receiving, from a UE, an indication of a set of multiple beams received by the UE. The resource set transmission component 1030 may be configured as or otherwise support a means for transmitting, based on receiving the indication, a message indicating at least a first resource set associated with one or more first beams from the set of multiple beams and a second resource set associated with one or more second beams from the set of multiple beams. The correlation report component 1035 may be configured as or otherwise support a means for receiving a report indicative of a level of correlation between pairs of individual beams, each pair including a first individual beam of the one or more first beams and a second individual beam of the one or more second beams. The communicating component 1040 may be configured as or otherwise support a means for communicating with the UE via a selected beam of the one or more first beams or the one or more second beams.

In some examples, the signal transmission component 1045 may be configured as or otherwise support a means for transmitting the signal to the UE via at least a first RIS and a second RIS.

In some examples, the beam indication component 1025 may be configured as or otherwise support a means for determining that the indication of the set of multiple beams includes the one or more first beams associated with the first a RIS and includes the one or more second beams associated with the second RIS. In some examples, the resource set determination component 1055 may be configured as or otherwise support a means for determining the first resource set and the second resource set based on the indication of the set of multiple beams including beams associated with different RISs.

In some examples, to support determining the first resource set and the second resource set, the resource set determination component 1055 may be configured as or otherwise support a means for determining a size of the first resource set based on a number of beams included in the one or more first beams and a size of the second resource set based on a number of beams included in the one or more second beams.

In some examples, to support communicating with the UE via the selected beam, the beam selection component 1060 may be configured as or otherwise support a means for selecting a beam to communicate with the UE based on the report, where the selected beam is based on the selecting. In some examples, to support communicating with the UE via the selected beam, the communicating component 1040 may be configured as or otherwise support a means for communicating with the UE via the selected beam, where the selected beam is associated with the first RIS or the second RIS.

In some examples, the communicating component 1040 may be configured as or otherwise support a means for determining a second beam to communicate with a second UE based on the report and the selected beam.

In some examples, the signal transmission component 1045 may be configured as or otherwise support a means for transmitting a second signal to the UE via the one or more first beams of the first RIS and the one or more second beams of the second RIS based on transmitting the message indicating the first resource set and the second resource set.

In some examples, the correlation report component 1035 may be configured as or otherwise support a means for receiving a set of multiple reports indicative of the level of correlation between pairs of individual beams. In some examples, the beam indication component 1025 may be configured as or otherwise support a means for identifying one or more individual beams indicated in more than one of the set of multiple reports. In some examples, the beam prohibiting component 1050 may be configured as or otherwise support a means for determining to prohibit communications via the one or more individual beams based on the one or more individual beams being indicated in the more than one of the set of multiple reports.

In some examples, the RIS determination component 1065 may be configured as or otherwise support a means for determining a RIS associated with the one or more individual beams. In some examples, the RIS determination component 1065 may be configured as or otherwise support a means for transmitting a message to the RIS prohibiting use of the one or more individual beams by the RIS.

In some examples, to support receiving the report, the correlation report component 1035 may be configured as or otherwise support a means for receiving the report including an indication of the level of correlation for a top number of beam pairs associated with a highest level of correlation.

In some examples, the level of correlation includes a resource index associated with the first resource set or the second resource set for each of the top number of beam pairs.

In some examples, the report includes a measured level of correlation between the individual beams in each pair.

In some examples, to support receiving the indication of the set of multiple beams, the beam indication component 1025 may be configured as or otherwise support a means for receiving a measurement associated with each of the set of multiple beams.

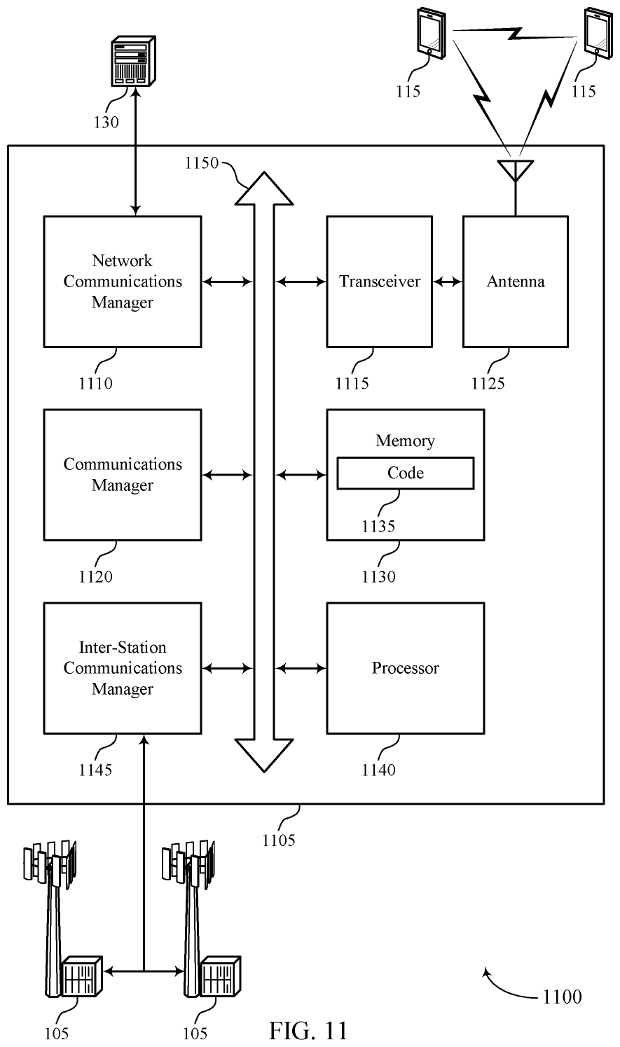

FIG. 11 shows a diagram of a system 1100 including a device 1105 that supports techniques for configuring communications associated with RISs in accordance with aspects of the present disclosure. The device 1105 may be an example of or include the components of a device 805, a device 905, or a base station 105 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, a network communications manager 1110, a transceiver 1115, an antenna 1125, a memory 1130, code 1135, a processor 1140, and an inter-station communications manager 1145. These components may be in electronic communication or otherwise coupled (e.g., operatively, communicatively, functionally, electronically, electrically) via one or more buses (e.g., a bus 1150).

The network communications manager 1110 may manage communications with a core network 130 (e.g., via one or more wired backhaul links). For example, the network communications manager 1110 may manage the transfer of data communications for client devices, such as one or more UEs 115.

In some cases, the device 1105 may include a single antenna 1125. However, in some other cases the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include RAM and ROM. The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a BIOS which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for configuring communications associated with RISs). For example, the device 1105 or a component of the device 1105 may include a processor 1140 and memory 1130 coupled to the processor 1140, the processor 1140 and memory 1130 configured to perform various functions described herein.

The inter-station communications manager 1145 may manage communications with other base stations 105, and may include a controller or scheduler for controlling communications with UEs 115 in cooperation with other base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communications network technology to provide communication between base stations 105.

The communications manager 1120 may support wireless communications at a base station in accordance with examples as disclosed herein. For example, the communications manager 1120 may be configured as or otherwise support a means for receiving, from a UE, an indication of a set of multiple beams received by the UE. The communications manager 1120 may be configured as or otherwise support a means for transmitting, based on receiving the indication, a message indicating at least a first resource set associated with one or more first beams from the set of multiple beams and a second resource set associated with one or more second beams from the set of multiple beams. The communications manager 1120 may be configured as or otherwise support a means for receiving a report indicative of a level of correlation between pairs of individual beams, each pair including a first individual beam of the one or more first beams and a second individual beam of the one or more second beams. The communications manager 1120 may be configured as or otherwise support a means for communicating with the UE via a selected beam of the one or more first beams or the one or more second beams.

By including or configuring the communications manager 1120 in accordance with examples as described herein, the device 1105 may support techniques for improved communication reliability, reduced latency, more efficient utilization of communication resources, and improved coordination between devices.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for configuring communications associated with RISs as described herein, or the processor 1140 and the memory 1130 may be otherwise configured to perform or support such operations.

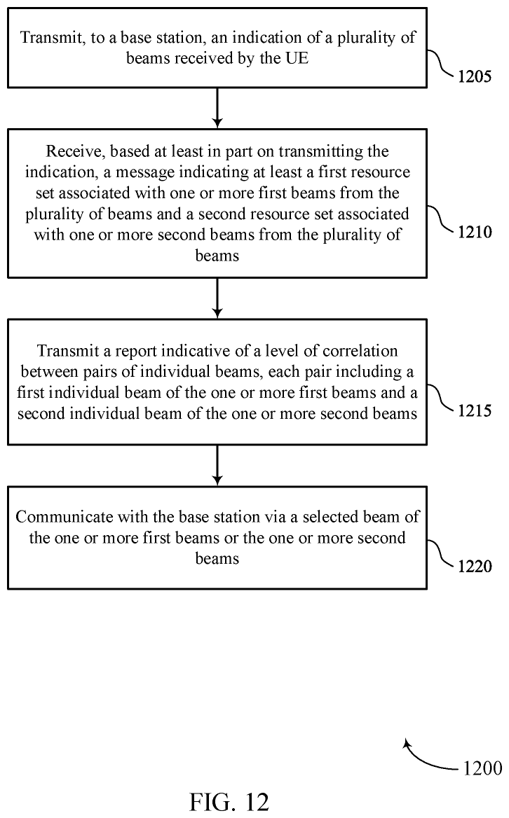

FIG. 12 shows a flowchart illustrating a method 1200 that supports techniques for configuring communications associated with RISs in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1205, the method may include transmitting, to a base station, an indication of a set of multiple beams received by the UE. The operations of 1205 may be performed in accordance with examples as disclosed herein. In some examples, aspects of the operations of 1205 may be performed by a beam indication manager 625 as described with reference to FIG. 6.

At 1210, the method may include receiving, based on transmitting the indication, a message indicating at least a first resource set associated with one or more first beams from the set of multiple beams and a second resource set associated with one or more second beams from the set of multiple beams. The operations of 1210 may be performed in accordance with examples as disclosed herein. In some examples, aspects of the operations of 1210 may be performed by a resource set reception manager 630 as described with reference to FIG. 6.

At 1215, the method may include transmitting a report indicative of a level of correlation between pairs of individual beams, each pair including a first individual beam of the one or more first beams and a second individual beam of the one or more second beams. The operations of 1215 may be performed in accordance with examples as disclosed herein. In some examples, aspects of the operations of 1215 may be performed by a correlation report manager 635 as described with reference to FIG. 6.

At 1220, the method may include communicating with the base station via a selected beam of the one or more first beams or the one or more second beams. The operations of 1220 may be performed in accordance with examples as disclosed herein. In some examples, aspects of the operations of 1220 may be performed by a communicating manager 640 as described with reference to FIG. 6.

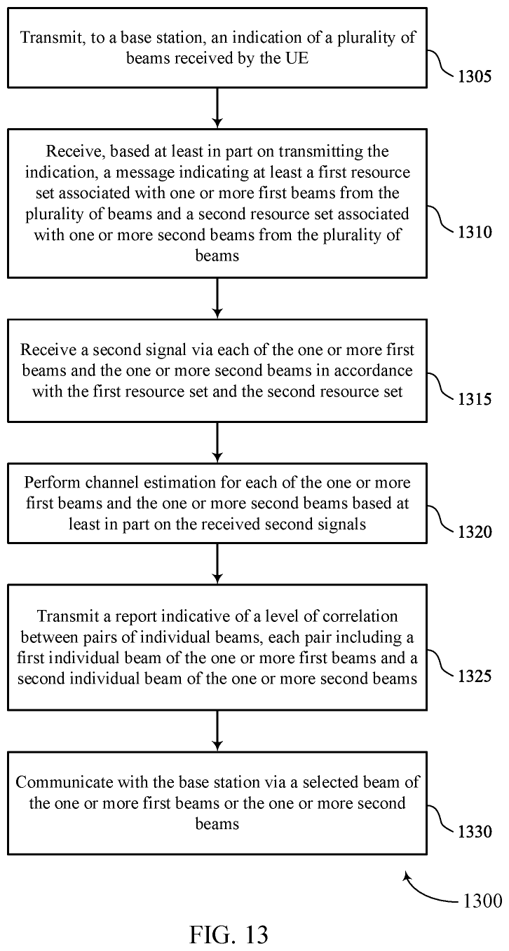

FIG. 13 shows a flowchart illustrating a method 1300 that supports techniques for configuring communications associated with RISs in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1305, the method may include transmitting, to a base station, an indication of a set of multiple beams received by the UE. The operations of 1305 may be performed in accordance with examples as disclosed herein. In some examples, aspects of the operations of 1305 may be performed by a beam indication manager 625 as described with reference to FIG. 6.

At 1310, the method may include receiving, based on transmitting the indication, a message indicating at least a first resource set associated with one or more first beams from the set of multiple beams and a second resource set associated with one or more second beams from the set of multiple beams. The operations of 1310 may be performed in accordance with examples as disclosed herein. In some examples, aspects of the operations of 1310 may be performed by a resource set reception manager 630 as described with reference to FIG. 6.

At 1315, the method may include receiving a second signal via each of the one or more first beams and the one or more second beams in accordance with the first resource set and the second resource set. The operations of 1315 may be performed in accordance with examples as disclosed herein. In some examples, aspects of the operations of 1315 may be performed by a signal reception manager 645 as described with reference to FIG. 6.

At 1320, the method may include performing channel estimation for each of the one or more first beams and the one or more second beams based on the received second signals. The operations of 1320 may be performed in accordance with examples as disclosed herein. In some examples, aspects of the operations of 1320 may be performed by a channel estimation manager 650 as described with reference to FIG. 6.

At 1325, the method may include transmitting a report indicative of a level of correlation between pairs of individual beams, each pair including a first individual beam of the one or more first beams and a second individual beam of the one or more second beams. The operations of 1325 may be performed in accordance with examples as disclosed herein. In some examples, aspects of the operations of 1325 may be performed by a correlation report manager 635 as described with reference to FIG. 6.

At 1330, the method may include communicating with the base station via a selected beam of the one or more first beams or the one or more second beams. The operations of 1330 may be performed in accordance with examples as disclosed herein. In some examples, aspects of the operations of 1330 may be performed by a communicating manager 640 as described with reference to FIG. 6.

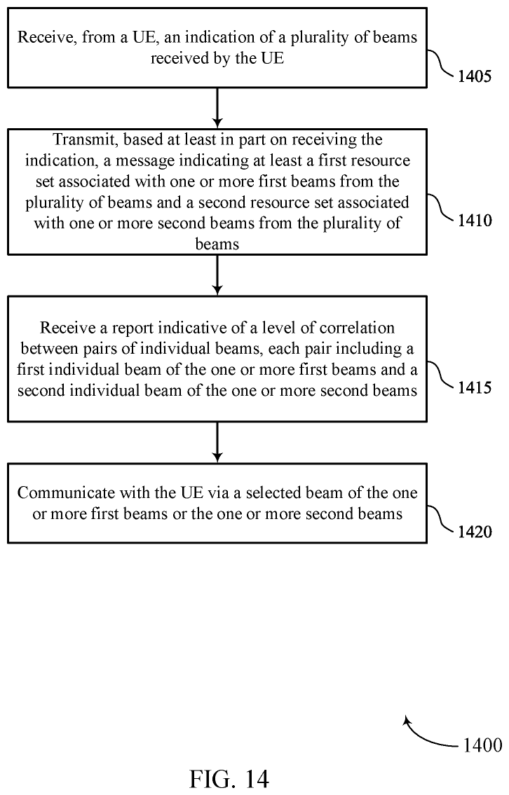

FIG. 14 shows a flowchart illustrating a method 1400 that supports techniques for configuring communications associated with RISs in accordance with aspects of the present disclosure. The operations of the method 1400 may be implemented by a base station or its components as described herein. For example, the operations of the method 1400 may be performed by a base station 105 as described with reference to FIGS. 1 through 3 and 8 through 11. In some examples, a base station may execute a set of instructions to control the functional elements of the base station to perform the described functions. Additionally or alternatively, the base station may perform aspects of the described functions using special-purpose hardware.

At 1405, the method may include receiving, from a UE, an indication of a set of multiple beams received by the UE. The operations of 1405 may be performed in accordance with examples as disclosed herein. In some examples, aspects of the operations of 1405 may be performed by a beam indication component 1025 as described with reference to FIG. 10.

At 1410, the method may include transmitting, based on receiving the indication, a message indicating at least a first resource set associated with one or more first beams from the set of multiple beams and a second resource set associated with one or more second beams from the set of multiple beams. The operations of 1410 may be performed in accordance with examples as disclosed herein. In some examples, aspects of the operations of 1410 may be performed by a resource set transmission component 1030 as described with reference to FIG. 10.

At 1415, the method may include receiving a report indicative of a level of correlation between pairs of individual beams, each pair including a first individual beam of the one or more first beams and a second individual beam of the one or more second beams. The operations of 1415 may be performed in accordance with examples as disclosed herein. In some examples, aspects of the operations of 1415 may be performed by a correlation report component 1035 as described with reference to FIG. 10.

At 1420, the method may include communicating with the UE via a selected beam of the one or more first beams or the one or more second beams. The operations of 1420 may be performed in accordance with examples as disclosed herein. In some examples, aspects of the operations of 1420 may be performed by a communicating component 1040 as described with reference to FIG. 10.

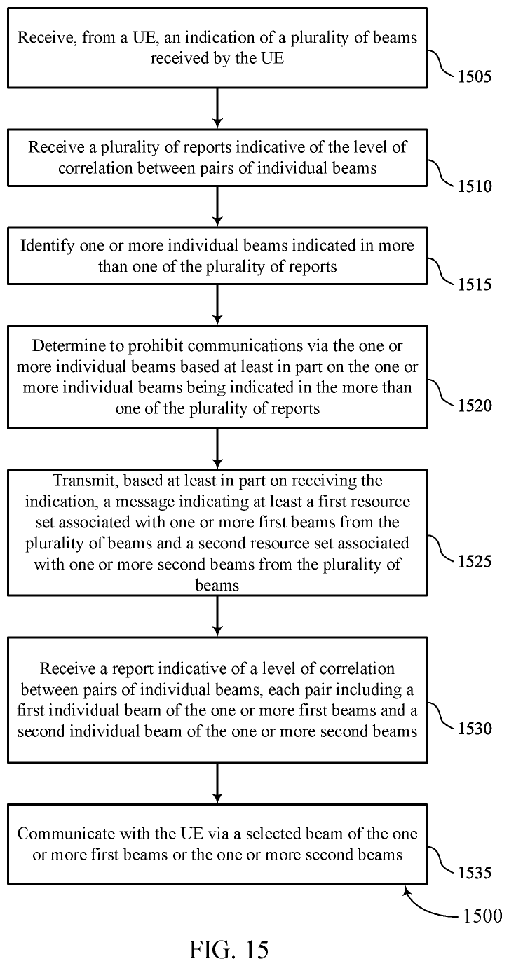

FIG. 15 shows a flowchart illustrating a method 1500 that supports techniques for configuring communications associated with RISs in accordance with aspects of the present disclosure. The operations of the method 1500 may be implemented by a base station or its components as described herein. For example, the operations of the method 1500 may be performed by a base station 105 as described with reference to FIGS. 1 through 3 and 8 through 11. In some examples, a base station may execute a set of instructions to control the functional elements of the base station to perform the described functions. Additionally or alternatively, the base station may perform aspects of the described functions using special-purpose hardware.

At 1505, the method may include receiving, from a UE, an indication of a set of multiple beams received by the UE. The operations of 1505 may be performed in accordance with examples as disclosed herein. In some examples, aspects of the operations of 1505 may be performed by a beam indication component 1025 as described with reference to FIG. 10.

At 1510, the method may include receiving a set of multiple reports indicative of the level of correlation between pairs of individual beams. The operations of 1510 may be performed in accordance with examples as disclosed herein. In some examples, aspects of the operations of 1510 may be performed by a correlation report component 1035 as described with reference to FIG. 10.

At 1515, the method may include identifying one or more individual beams indicated in more than one of the set of multiple reports. The operations of 1515 may be performed in accordance with examples as disclosed herein. In some examples, aspects of the operations of 1515 may be performed by a beam indication component 1025 as described with reference to FIG. 10.

At 1520, the method may include determining to prohibit communications via the one or more individual beams based on the one or more individual beams being indicated in the more than one of the set of multiple reports. The operations of 1520 may be performed in accordance with examples as disclosed herein. In some examples, aspects of the operations of 1520 may be performed by a beam prohibiting component 1050 as described with reference to FIG. 10.

At 1525, the method may include transmitting, based on receiving the indication, a message indicating at least a first resource set associated with one or more first beams from the set of multiple beams and a second resource set associated with one or more second beams from the set of multiple beams. The operations of 1525 may be performed in accordance with examples as disclosed herein. In some examples, aspects of the operations of 1525 may be performed by a resource set transmission component 1030 as described with reference to FIG. 10.

At 1530, the method may include receiving a report indicative of a level of correlation between pairs of individual beams, each pair including a first individual beam of the one or more first beams and a second individual beam of the one or more second beams. The operations of 1530 may be performed in accordance with examples as disclosed herein. In some examples, aspects of the operations of 1530 may be performed by a correlation report component 1035 as described with reference to FIG. 10.

At 1535, the method may include communicating with the UE via a selected beam of the one or more first beams or the one or more second beams. The operations of 1535 may be performed in accordance with examples as disclosed herein. In some examples, aspects of the operations of 1535 may be performed by a communicating component 1040 as described with reference to FIG. 10.

The following provides an overview of aspects of the present disclosure:
Aspect 1: A method for wireless communications at a UE, comprising: transmitting, to a base station, an indication of a plurality of beams received by the UE; receiving, based at least in part on transmitting the indication, a message indicating at least a first resource set associated with one or more first beams from the plurality of beams and a second resource set associated with one or more second beams from the plurality of beams; transmitting a report indicative of a level of correlation between pairs of individual beams, each pair including a first individual beam of the one or more first beams and a second individual beam of the one or more second beams; and communicating with the base station via a selected beam of the one or more first beams or the one or more second beams.
Aspect 2: The method of aspect, further comprising: receiving a second signal via each of the one or more first beams and the one or more second beams in accordance with the first resource set and the second resource set; and performing channel estimation for each of the one or more first beams and the one or more second beams based at least in part on the received second signals.
Aspect 3: The method of aspect, further comprising: determining the level of correlation between the individual beams in each pair based at least in part on the channel estimation of the one or more first beams and the one or more second beams.
Aspect 4: The method of any of aspects through, wherein transmitting the report further comprises: transmitting the report comprising an indication of the level of correlation for a top number of beam pairs associated with a highest level of correlation.
Aspect 5: The method of aspect, wherein the level of correlation comprises a pair of resource indices for each of the top number of beam pairs, a first resource index associated with the first resource set and a second resource index associated with the second resource set.
Aspect 6: The method of any of aspects through, further comprising: ranking levels of correlations for each pair from the highest level of correlation to a lowest level of correlation, wherein the indication comprises the ranked list.
Aspect 7: The method of any of aspects through, wherein the report comprises a measured level of correlation between the individual beams in each pair.
Aspect 8: The method of any of aspects through, wherein transmitting the indication of the plurality of beams further comprises: measuring a plurality of signals received by the UE, each signal of the plurality of signals received over a different beam of the plurality of beams, wherein the indication of the plurality of beams is based at least in part on the measuring and comprises a number of strongest measured signals.
Aspect 9: The method of aspect, wherein transmitting the indication of the plurality of beams further comprises: transmitting a measurement associated with each of the plurality of beams.
Aspect 10: The method of any of aspects through, wherein transmitting the indication of the plurality of beams is based at least in part on the plurality of beams being associated with a measured signal greater than a threshold.
Aspect 11: The method of any of aspects through, wherein the first resource set is associated with a first reconfigurable intelligent surface and the second resource set is associated with a second reconfigurable intelligent surface.
Aspect 12: The method of aspect, wherein a size of the first resource set is based at least in part on the plurality of beams received by the UE via the first reconfigurable intelligent surface and a size of the second resource set is based at least in part on the plurality of beams received by the UE via the second reconfigurable intelligent surface.
Aspect 13: The method of any of aspects through, wherein communicating with the base station via the selected beam further comprises: communicating with the base station via the selected beam and the first reconfigurable intelligent surface or the second reconfigurable intelligent surface.
Aspect 14: A method for wireless communications at a base station, comprising: receiving, from a UE, an indication of a plurality of beams received by the UE; transmitting, based at least in part on receiving the indication, a message indicating at least a first resource set associated with one or more first beams from the plurality of beams and a second resource set associated with one or more second beams from the plurality of beams; receiving a report indicative of a level of correlation between pairs of individual beams, each pair including a first individual beam of the one or more first beams and a second individual beam of the one or more second beams; and communicating with the UE via a selected beam of the one or more first beams or the one or more second beams.
Aspect 15: The method of aspect, further comprising: transmitting the signal to the UE via at least a first reconfigurable intelligent surface and a second reconfigurable intelligent surface.
Aspect 16: The method of aspect, further comprising: determining that the indication of the plurality of beams comprises the one or more first beams associated with the first a reconfigurable intelligent surface and comprises the one or more second beams associated with the second reconfigurable intelligent surface; and determining the first resource set and the second resource set based at least in part on the indication of the plurality of beams comprising beams associated with different reconfigurable intelligent surfaces.
Aspect 17: The method of aspect, wherein determining the first resource set and the second resource set further comprises: determining a size of the first resource set based at least in part on a number of beams included in the one or more first beams and a size of the second resource set based at least in part on a number of beams included in the one or more second beams.
Aspect 18: The method of any of aspects through, wherein communicating with the UE via the selected beam further comprises: selecting a beam to communicate with the UE based at least in part on the report, wherein the selected beam is based at least in part on the selecting; and communicating with the UE via the selected beam, wherein the selected beam is associated with the first reconfigurable intelligent surface or the second reconfigurable intelligent surface.
Aspect 19: The method of aspect, further comprising: determining a second beam to communicate with a second UE based at least in part on the report and the selected beam.
Aspect 20: The method of any of aspects through, further comprising: transmitting a second signal to the UE via the one or more first beams of the first reconfigurable intelligent surface and the one or more second beams of the second reconfigurable intelligent surface based at least in part on transmitting the message indicating the first resource set and the second resource set.
Aspect 21: The method of any of aspects through, further comprising: receiving a plurality of reports indicative of the level of correlation between pairs of individual beams; identifying one or more individual beams indicated in more than one of the plurality of reports; and determining to prohibit communications via the one or more individual beams based at least in part on the one or more individual beams being indicated in the more than one of the plurality of reports.
Aspect 22: The method of aspect, further comprising: determining a reconfigurable intelligent surface associated with the one or more individual beams; and transmitting a message to the reconfigurable intelligent surface prohibiting use of the one or more individual beams by the reconfigurable intelligent surface.
Aspect 23: The method of any of aspects through, wherein receiving the report further comprises: receiving the report comprising an indication of the level of correlation for a top number of beam pairs associated with a highest level of correlation.
Aspect 24: The method of aspect, wherein the level of correlation comprises a resource index associated with the first resource set or the second resource set for each of the top number of beam pairs.
Aspect 25: The method of any of aspects through, wherein the report comprises a measured level of correlation between the individual beams in each pair.
Aspect 26: The method of any of aspects through, wherein receiving the indication of the plurality of beams further comprises: receiving a measurement associated with each of the plurality of beams.
Aspect 27: An apparatus for wireless communications at a UE, comprising a processor; memory coupled with the processor; and instructions stored in the memory and executable by the processor to cause the apparatus to perform a method of any of aspects through.
Aspect 28: An apparatus for wireless communications at a UE, comprising at least one means for performing a method of any of aspects through.
Aspect 29: A non-transitory computer-readable medium storing code for wireless communications at a UE, the code comprising instructions executable by a processor to perform a method of any of aspects through
Aspect 30: An apparatus for wireless communications at a base station, comprising a processor; memory coupled with the processor; and instructions stored in the memory and executable by the processor to cause the apparatus to perform a method of any of aspects through.
Aspect 31: An apparatus for wireless communications at a base station, comprising at least one means for performing a method of any of aspects through.
Aspect 32: A non-transitory computer-readable medium storing code for wireless communications at a base station, the code comprising instructions executable by a processor to perform a method of any of aspects through.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
transmitting, to a base station, an indication of a plurality of beams received by the UE;
receiving, based at least in part on transmitting the indication, a message indicating at least a first resource set associated with one or more first beams from the plurality of beams and a second resource set associated with one or more second beams from the plurality of beams;
transmitting a report indicative of a level of correlation between pairs of individual beams, each pair including a first individual beam of the one or more first beams and a second individual beam of the one or more second beams; and
communicating with the base station via a selected beam of the one or more first beams or the one or more second beams.

2. The method of claim 1, further comprising:
receiving a second signal via each of the one or more first beams and the one or more second beams in accordance with the first resource set and the second resource set; and
performing channel estimation for each of the one or more first beams and the one or more second beams based at least in part on the received second signals.

3. The method of claim 2, further comprising:
determining the level of correlation between the individual beams in each pair based at least in part on the channel estimation of the one or more first beams and the one or more second beams.

4. The method of claim 1, wherein transmitting the report further comprises:
transmitting the report comprising an indication of the level of correlation for a top number of beam pairs associated with a highest level of correlation.

5. The method of claim 4, wherein the level of correlation comprises a pair of resource indices for each of the top number of beam pairs, a first resource index associated with the first resource set and a second resource index associated with the second resource set.

6. The method of claim 4, further comprising:
ranking levels of correlations for each pair from the highest level of correlation to a lowest level of correlation, wherein the indication comprises the ranked list.

7. The method of claim 1, wherein the report comprises a measured level of correlation between the individual beams in each pair.

8. The method of claim 1, wherein transmitting the indication of the plurality of beams further comprises:
measuring a plurality of signals received by the UE, each signal of the plurality of signals received over a different beam of the plurality of beams, wherein the indication of the plurality of beams is based at least in part on the measuring and comprises a number of strongest measured signals.

9. The method of claim 8, wherein transmitting the indication of the plurality of beams further comprises:
transmitting a measurement associated with each of the plurality of beams.

10. The method of claim 8, wherein transmitting the indication of the plurality of beams is based at least in part on the plurality of beams being associated with a measured signal greater than a threshold.

11. The method of claim 1, wherein the first resource set is associated with a first reconfigurable intelligent surface and the second resource set is associated with a second reconfigurable intelligent surface.

12. The method of claim 11, wherein a size of the first resource set is based at least in part on the plurality of beams received by the UE via the first reconfigurable intelligent surface and a size of the second resource set is based at least in part on the plurality of beams received by the UE via the second reconfigurable intelligent surface.

13. The method of claim 11, wherein communicating with the base station via the selected beam further comprises:
communicating with the base station via the selected beam and the first reconfigurable intelligent surface or the second reconfigurable intelligent surface.

14. A method for wireless communications at a base station, comprising:
receiving, from a user equipment (UE), an indication of a plurality of beams received by the UE;
transmitting, based at least in part on receiving the indication, a message indicating at least a first resource set associated with one or more first beams from the plurality of beams and a second resource set associated with one or more second beams from the plurality of beams;
receiving a report indicative of a level of correlation between pairs of individual beams, each pair including a first individual beam of the one or more first beams and a second individual beam of the one or more second beams; and
communicating with the UE via a selected beam of the one or more first beams or the one or more second beams.

15. The method of claim 14, further comprising:
transmitting the signal to the UE via at least a first reconfigurable intelligent surface and a second reconfigurable intelligent surface.

16. The method of claim 15, further comprising:
determining that the indication of the plurality of beams comprises the one or more first beams associated with the first a reconfigurable intelligent surface and comprises the one or more second beams associated with the second reconfigurable intelligent surface; and
determining the first resource set and the second resource set based at least in part on the indication of the plurality of beams comprising beams associated with different reconfigurable intelligent surfaces.

17. The method of claim 16, wherein determining the first resource set and the second resource set further comprises:
determining a size of the first resource set based at least in part on a number of beams included in the one or more first beams and a size of the second resource set based at least in part on a number of beams included in the one or more second beams.

18. The method of claim 15, wherein communicating with the UE via the selected beam further comprises:
selecting a beam to communicate with the UE based at least in part on the report, wherein the selected beam is based at least in part on the selecting; and
communicating with the UE via the selected beam, wherein the selected beam is associated with the first reconfigurable intelligent surface or the second reconfigurable intelligent surface.

19. The method of claim 18, further comprising:
determining a second beam to communicate with a second UE based at least in part on the report and the selected beam.

20. The method of claim 15, further comprising:
transmitting a second signal to the UE via the one or more first beams of the first reconfigurable intelligent surface and the one or more second beams of the second reconfigurable intelligent surface based at least in part on transmitting the message indicating the first resource set and the second resource set.

21. The method of claim 14, further comprising:
receiving a plurality of reports indicative of the level of correlation between pairs of individual beams;
identifying one or more individual beams indicated in more than one of the plurality of reports; and
determining to prohibit communications via the one or more individual beams based at least in part on the one or more individual beams being indicated in the more than one of the plurality of reports.

22. The method of claim 21, further comprising:
determining a reconfigurable intelligent surface associated with the one or more individual beams; and
transmitting a message to the reconfigurable intelligent surface prohibiting use of the one or more individual beams by the reconfigurable intelligent surface.

23. The method of claim 14, wherein receiving the report further comprises:
receiving the report comprising an indication of the level of correlation for a top number of beam pairs associated with a highest level of correlation.

24. The method of claim 23, wherein the level of correlation comprises a resource index associated with the first resource set or the second resource set for each of the top number of beam pairs.

25. The method of claim 14, wherein the report comprises a measured level of correlation between the individual beams in each pair.

26. The method of claim 14, wherein receiving the indication of the plurality of beams further comprises:
receiving a measurement associated with each of the plurality of beams.

27. An apparatus for wireless communications, comprising:
a processor;
memory coupled with the processor; and
instructions stored in the memory and executable by the processor to cause the apparatus to:
transmit, to a base station, an indication of a plurality of beams received by a user equipment (UE);
receive, based at least in part on transmitting the indication, a message indicating at least a first resource set associated with one or more first beams from the plurality of beams and a second resource set associated with one or more second beams from the plurality of beams;
transmit a report indicative of a level of correlation between pairs of individual beams, each pair including a first individual beam of the one or more first beams and a second individual beam of the one or more second beams; and
communicate with the base station via a selected beam of the one or more first beams or the one or more second beams.

28. The apparatus of claim 27, wherein the instructions are further executable by the processor to cause the apparatus to:
receive a second signal via each of the one or more first beams and the one or more second beams in accordance with the first resource set and the second resource set; and
perform channel estimation for each of the one or more first beams and the one or more second beams based at least in part on the received second signals.

29. An apparatus for wireless communications, comprising:
a processor;
memory coupled with the processor; and
instructions stored in the memory and executable by the processor to cause the apparatus to:
receive, from a user equipment (UE), an indication of a plurality of beams received by the UE;
transmit, based at least in part on receiving the indication, a message indicating at least a first resource set associated with one or more first beams from the plurality of beams and a second resource set associated with one or more second beams from the plurality of beams;
receive a report indicative of a level of correlation between pairs of individual beams, each pair including a first individual beam of the one or more first beams and a second individual beam of the one or more second beams; and
communicate with the UE via a selected beam of the one or more first beams or the one or more second beams.

30. The apparatus of claim 29, wherein the instructions are further executable by the processor to cause the apparatus to:
transmit the signal to the UE via at least a first reconfigurable intelligent surface and a second reconfigurable intelligent surface.
